(19) United States
(12) Patent Application Publication
(10) Pub. No.: US 2025/0058953 A1
(43) Pub. Date: Feb. 20, 2025

(54) SHIPPING MAILER WITH CORRUGATED MATERIAL HAVING ADHERED AND NON-ADHERED ZONES

(71) Applicant: Packaging Corporation of America, Lake Forest, IL (US)

(72) Inventors: Keith A. Jackson, Mundelein, IL (US); James D. Southwell, Long Grove, IL (US); Ellsworth L. Townsend, Lakeland, FL (US)

(73) Assignee: Packaging Corporation of America, Lake Forest, IL (US)

(21) Appl. No.: 18/935,969

(22) Filed: Nov. 4, 2024

Related U.S. Application Data
(63) Continuation of application No. PCT/US2023/021203, filed on May 5, 2023.
(60) Provisional application No. 63/339,309, filed on May 6, 2022.
(60) Provisional application No. 63/339,360, filed on May 6, 2022.

(51) Int. Cl. B65D 81/03; B65D 27/14; B65D 27/34

(52) U.S. Cl. CPC B65D 81/03; B65D 27/14; B65D 27/34

(57) ABSTRACT

A shipping mailer has a one-piece body with a first wall and a second wall that are folded together and sealed along sealed side edge portions of the one-piece body, the shipping mailer having a closed first end portion and a second end portion with an opening sealable by a closure. The one-piece body includes a single face corrugated material with a liner layer and a fluted medium layer, and has a center fold line at the closed first end portion from which the first and second walls extend. The fluted medium layer has a plurality of flutes extending parallel to the center fold line, and flutes of the first wall nest with flutes of the second wall. The flutes are crushed in the sealed side edge portions such that the crushed flutes interlock, and the first and second walls fold along inner boundaries of the sealed side edge portions.

### CROSS REFERENCE TO RELATED APPLICATIONS

This application is a continuation of International Application No. PCT/US2023/021203, filed May 5, 2023, which claims the benefit of U.S. Provisional Application No. 63/339,309, filed May 6, 2022, and which also claims the benefit of U.S. Provisional Application No. 63/339,360, filed May 6, 2022. Each of the foregoing applications is incorporated herein by reference in its entirety.

### FIELD

The present disclosure pertains to shipping mailers made from single face corrugated material, perforated tear-off strips for use with shipping mailers, and systems and methods of producing edged single face corrugated materials.

### BACKGROUND

Many existing soft-sided shipping mailers such as cushioned or padded envelopes are made at least partially if not entirely of polymeric materials such as plastics that are not biodegradable and/or cannot be economically recycled, if at all. However, shipping mailers made entirely of fiber-based paper materials can be too rigid, restricting the shipping mailer's ability to accommodate items in its interior. Another common feature of existing mailers is a plastic opener mechanism such as a tear tape or tear string. These single-use plastic items generate waste, and frequently contaminate recycled material streams when not fully separated from the mailer or tucked inside the mailer by the user. Thus, there exists a need for improvements to soft-sided shipping mailers.

Additionally, in certain packaging applications it can be advantageous to produce single face web in which the liner extends laterally beyond the corrugated medium, known as edged single face. This can facilitate, for example, face-to-face sealing between liner surfaces. Double-faced corrugated board in which the liner extends beyond the corrugated medium can also be advantageous for producing closed-edge corrugated, in which the laterally extending “fin” of the liner is folded over to cover and seal the open flutes at the edges of the corrugated board. However, producing these styles of single face and double-faced corrugated requires running non-standard widths of liner and medium through corrugator machinery, which poses handling problems and significantly reduces efficiency. Accordingly, a need also exists for improved systems and methods of producing edged single face and closed-edge corrugated.

### SUMMARY

Certain examples of the disclosure pertain to shipping mailers comprising a one-piece body comprising a first wall and a second wall that are folded together and sealed along sealed side edge portions of the one-piece body, the first and second walls at least partially defining an interior of the shipping mailer, the shipping mailer comprising a closed first end portion and a second end portion comprising an opening scalable by a closure. The one-piece body comprises a single face corrugated material comprising a liner layer and a fluted medium layer. The one-piece body comprises a center fold line at the closed first end portion from which the first and second walls extend, and the fluted medium layer comprises a plurality of flutes extending parallel or substantially parallel to the center fold line, wherein flutes of the first wall nest with flutes of the second wall.

In any or all of the examples disclosed herein, the flutes are crushed in the sealed side edge portions such that the crushed flutes interlock in the sealed side edge portions, and the first and second walls fold along inner boundaries of the sealed side edge portions.

In another representative example, a shipping mailer comprises a one-piece body comprising a first wall and a second wall that are folded together and sealed along sealed side edge portions of the one-piece body, the first and second walls at least partially defining an interior of the shipping mailer, the shipping mailer comprising a closed first end portion and a second end portion comprising an opening scalable by a closure; the one-piece body comprising a single face corrugated material comprising a liner layer and a fluted medium layer; the one-piece body comprising a center fold line at the closed first end portion from which the first and second walls extend; the fluted medium layer comprising a plurality of flutes extending parallel or substantially parallel to the center fold line, wherein flutes of the first wall nest with flutes of the second wall; and wherein the flutes are crushed in the sealed side edge portions such that the crushed flutes interlock in the sealed side edge portions, and the first and second walls fold along inner boundaries of the sealed side edge portions.

In any or all of the examples disclosed herein, the fluted medium layer comprises a plurality of longitudinal fold lines formed in the flutes of the fluted medium layer.

In any or all of the examples disclosed herein, the longitudinal fold lines are offset inwardly from the sealed side edge portions.

In any or all of the examples disclosed herein, the fluted medium layer comprises a plurality of curved fold lines extending from the closed first end portion toward the opening of the second end portion, and the plurality of curved fold lines have respective concavities oriented toward sealed side edge portions of the shipping mailer.

In any or all of the examples disclosed herein, the fluted medium layer comprises a plurality of first zones extending along the first wall and the second wall, the plurality of first zones comprising adhesive such that the liner layer and the fluted medium layer are adhered to each other in the plurality of first zones; and wherein the fluted medium layer further comprises a second zone that is adhesive-free such that the liner layer and the fluted medium layer can move relative to each other in the adhesive-free second zone, the adhesive-free second zone being offset inwardly from the side edge portions of the one-piece body.

In any or all of the examples disclosed herein, the adhesive-free second zone of the fluted medium layer is bounded on both sides by a first zone comprising adhesive.

In any or all of the examples disclosed herein, the adhesive-free second zone is one of a plurality of adhesive-free second zones of the fluted medium layer.

In any or all of the examples disclosed herein, each adhesive-free second zone of the plurality of adhesive-free second zones is bordered on both sides by a first zone comprising adhesive.

In any or all of the examples disclosed herein, the fluted medium layer comprises a plurality of longitudinal fold lines formed in the flutes of the fluted medium layer, and the longitudinal fold lines are positioned in first zones of the fluted medium layer comprising adhesive.

In any or all of the examples disclosed herein, the shipping mailer further comprises a perforated tear-off strip formed along one side of the shipping mailer and extending in a direction from the closed first end portion toward the second end portion.

In any or all of the examples disclosed herein, the perforated tear-off strip comprises a first plurality of perforations formed in the first wall and a second plurality of perforations formed in the second wall.

In any or all of the examples disclosed herein, at least a portion of the perforations of the first plurality of perforations are aligned with perforations of the second plurality of perforations.

In any or all of the examples disclosed herein, at least a portion of the perforations of the first plurality of perforations are offset from perforations of the second plurality of perforations.

In any or all of the examples disclosed herein, the shipping mailer defines a longitudinal axis that is perpendicular or substantially perpendicular to flutes of the fluted medium layer; and perforations of the perforated tear-off strip comprise first portions that are parallel or substantially parallel to the longitudinal axis and second portions that extend toward a nearest side edge of the one-piece body at an angle to the longitudinal axis.

In any or all of the examples disclosed herein, the fluted medium layer comprises a plurality of curved fold lines extending from the closed first end portion toward the opening of the second end portion, and the plurality of curved fold lines have respective concavities oriented toward sealed side edge portions of the shipping mailer.

In any or all of the examples disclosed herein, the first and second walls each comprise a perforation, and the perforations are on opposite sides of the center fold line.

In any or all of the examples disclosed herein, the shipping mailer further comprises a perforation that extends from the first wall across the center fold line to the second wall.

In another representative example, a shipping mailer comprises a one-piece body comprising a first wall and a second wall that are folded together and sealed along sealed side edge portions of the one-piece body, the first and second walls at least partially defining an interior of the shipping mailer, the shipping mailer comprising a closed first end portion and a second end portion comprising an opening scalable by a closure; wherein the one-piece body comprises a single face corrugated material comprising a liner layer and a fluted medium layer; wherein the fluted medium layer comprises a plurality of first zones extending along the first wall and the second wall, the plurality of first zones comprising adhesive such that the liner layer and the fluted medium layer are adhered to each other in the plurality of first zones; and wherein the fluted medium layer further comprises a second zone that is adhesive-free such that the liner layer and the fluted medium layer can move relative to each other in the adhesive-free second zone, the adhesive-free second zone being offset inwardly from the side edge portions of the one-piece body.

In any or all of the examples disclosed herein, the adhesive-free second zone of the fluted medium layer is bounded on both sides by a first zone comprising adhesive.

In any or all of the examples disclosed herein, the adhesive-free second zone is one of a plurality of adhesive-free second zones of the fluted medium layer.

In any or all of the examples disclosed herein, each adhesive-free second zone of the plurality of adhesive-free second zones is bordered on both sides by a first zone comprising adhesive.

In any or all of the examples disclosed herein, the one-piece body comprises a center fold line at the closed first end portion from which the first and second walls extend; and the fluted medium layer comprises a plurality of flutes extending parallel or substantially parallel to the center fold line.

In any or all of the examples disclosed herein, the fluted medium layer comprises a plurality of longitudinal fold lines formed in flutes of the fluted medium layer, and the longitudinal fold lines are positioned in first zones of the fluted medium layer comprising adhesive.

In any or all of the examples disclosed herein, the longitudinal fold lines extend along inner edges of the sealed side edge portions of the shipping mailer.

In any or all of the examples disclosed herein, a width of the fluted medium layer is equal to a width of the liner layer such that the flutes of the fluted medium layer extend from one side edge of the one-piece body to the other side edge of the one-piece body; and the flutes are crushed in the sealed side edge portions of the one-piece body.

In any or all of the examples disclosed herein, the single face corrugated material is edged single face corrugated material and the liner layer extends beyond side edges of the fluted medium layer.

In any or all of the examples disclosed herein, the fluted medium layer comprises a plurality of curved fold lines extending from the closed first end portion toward the opening of the second end portion, and the plurality of curved fold lines have respective concavities oriented toward sealed side edge portions of the shipping mailer.

In any or all of the examples disclosed herein, the shipping mailer further comprises a perforated tear-off strip formed along one side of the shipping mailer and extending in a direction from the closed first end portion toward the second end portion.

In any or all of the examples disclosed herein, the perforated tear-off strip comprises a first plurality of perforations formed in the first wall and a second plurality of perforations formed in the second wall.

In any or all of the examples disclosed herein, at least a portion of the perforations of the first plurality of perforations are aligned with perforations of the second plurality of perforations.

In any or all of the examples disclosed herein, at least a portion of the perforations of the first plurality of perforations are offset from perforations of the second plurality of perforations.

In any or all of the examples disclosed herein, the shipping mailer defines a longitudinal axis that is perpendicular or substantially perpendicular to flutes of the fluted medium layer; and perforations of the perforated tear-off strip comprise first portions that are parallel or substantially parallel to the longitudinal axis and second portions that extend toward a nearest side edge of the one-piece body at an angle to the longitudinal axis.

In any or all of the examples disclosed herein, flutes of the fluted medium layer extend parallel or substantially parallel to a center fold line of the shipping mailer, and flutes of the first wall nest with flutes of the second wall.

In another representative example, a shipping mailer comprises a one-piece body comprising a first wall and a second wall that are folded together and sealed along side edge portions of the one-piece body, the first and second walls at least partially defining an interior of the shipping mailer, the shipping mailer comprising a closed first end portion and a second end portion, the second end portion comprising an opening scalable by a closure; and a perforated tear-off strip formed along one side of the shipping mailer and extending in a direction from the closed first end portion toward the second end portion, the perforated tear-off strip comprising a first plurality of perforations formed in the first wall and a second plurality of perforations formed in the second wall.

Another representative example comprises a blank for forming the shipping mailer of any of the examples described herein.

In another representative example, a shipping mailer comprises a one-piece body comprising a first wall and a second wall that are folded together and sealed along sealed side edge portions of the one-piece body, the first and second walls at least partially defining an interior of the shipping mailer, the shipping mailer comprising a closed first end portion and a second end portion comprising an opening scalable by a closure; the one-piece body comprises a single face corrugated material comprising a liner layer and a fluted medium layer; the one-piece body comprises a center fold line at the closed first end portion from which the first and second walls extend; the fluted medium layer comprises a plurality of flutes extending parallel or substantially parallel to the center fold line; and wherein the fluted medium layer comprises longitudinal fold lines formed along inner edges of the sealed side edge portions.

The foregoing and other objects, features, and advantages of the disclosed technology will become more apparent from the following detailed description, which proceeds with reference to the accompanying figures.

### BRIEF DESCRIPTION OF THE DRAWINGS

FIG. 1A is a schematic block diagram of a representative example of a corrugator system.

FIG. 1B is a schematic block diagram of a representative example of a corrugator system set up for producing envelopes and related products.

FIG. 2 is a schematic side elevation view of a representative example of a single facer system.

FIG. 3 is a perspective view of a pair of corrugating rollers and an adhesive applicator system that selectively applies adhesive to fluted medium in discrete adhesive zones and adhesive-free zones.

FIG. 4 is another perspective view of one corrugating roller and fluted medium with adhesive-free zones being adhered to a sheet of liner.

FIG. 5 is a top plan view of a representative example of an adhesive reservoir including a plurality of dams positioned to create a plurality of discrete, spaced apart adhesive baths.

FIG. 6 is a perspective view of another example of a single facer system in which the applicator roller comprises reduced diameter portions along its length.

FIG. 7 is a perspective view of another example of single facer system comprising three spaced apart applicator rollers.

FIG. 8A is a perspective view of cutters removing material strips from a single face web at the location of adhesive-free zones of the fluted medium.

FIG. 8B is a perspective view of cutters removing material strips from a corrugated web.

FIG. 9 is a magnified view of a portion of a cutter of FIG. 8A showing partial depth cutting of the fluted medium.

FIG. 10 is a perspective view of a representative example of a shipping mailer.

FIG. 11 illustrates the shipping mailer of FIG. 10 in a laid-flat configuration.

FIG. 12 is a process flow diagram illustrating a representative method of producing single face web in which the fluted medium layer comprises zones with adhesive and adhesive-free zones.

FIG. 13 is a schematic plan view of an example of a single face corrugated blank for a shipping mailer illustrating the location of stripes of adhesive and adhesive-free stripes on the fluted medium layer of the blank.

FIGS. 14A and 14B are schematic plan views of the blank of FIG. 13 illustrating fold lines and knife cuts formed in the blanks.

FIG. 14C is a cross-sectional view schematically illustrating folding of the walls of a shipping mailer along the inner edges of sealed side edge portions of the shipping mailer.

FIG. 15 is a side view of an edge portion of the blank of FIG. 14A illustrating flutes of the first wall and the second wall nested together.

FIG. 16 is a side view of the edge portion of FIG. 15 showing the flutes after the edge portion has been crushed.

FIG. 17 is a schematic plan view of a portion of a shipping mailer made of single face corrugated material and comprising a perforated tear-off strip according to one example.

FIG. 18 is a side view of the shipping mailer of FIG. 17.

FIG. 19 is a schematic view showing exemplary perforations of the tear-off strip of FIG. 17.

FIG. 20 is a schematic view of a portion of shipping mailer comprising a perforated tear-off strip including a tear tab, according to another example.

FIG. 21 schematically illustrates the finned edge portion of a first wall of a shipping mailer side by side with the finned edge portion of a second wall of the shipping mailer, and a region along the walls where the perforations of a perforated tear-off strip are in phase and a region where the perforations are out of phase.

FIGS. 22A and 22B schematically illustrate another example of a blank for a shipping mailer comprising curved creases on both sides of the center fold line and perforated tear-off strips formed from perforations that are out of phase.

FIGS. 23A and 23B schematically illustrate another example of a blank for a shipping mailer comprising curved creases on both sides of the center fold line and perforated tear-off strips formed from perforations that are in phase.

FIGS. 24A and 24B schematically illustrate another example of a blank for a shipping mailer comprising perforated tear-off strips formed from perforations that are out of phase.

FIGS. 25A and 25B schematically illustrate another example of a blank for a shipping mailer comprising perforated tear-off strips formed from perforations that are in phase.

FIG. 26 is a plan view schematically illustrating another example of a blank for a shipping mailer comprising curved fold lines extending from the center fold line and a perforated tear-off strip.

### DETAILED DESCRIPTION

### Explanation of Terms

The following explanations of terms are provided to assist in understanding the present disclosure. For purposes of this description, certain aspects, advantages, and novel features of the embodiments of this disclosure are described herein. The disclosed methods, apparatus, and systems should not be construed as being limiting in any way. Instead, the present disclosure is directed toward all novel and nonobvious features and aspects of the various disclosed embodiments, alone and in various combinations and sub-combinations with one another. The methods, apparatus, and systems are not limited to any specific aspect or feature or combination thereof, nor do the disclosed embodiments require that any one or more specific advantages be present or problems be solved.

Although the operations of some of the disclosed embodiments are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

As used in this disclosure and in the claims, the singular forms “a,” “an,” and “the” include the plural forms unless the context clearly dictates otherwise. Additionally, the term “includes” means “comprises.” Further, the terms “coupled” and “associated” generally mean electrically, electromagnetically, and/or physically (e.g., mechanically or chemically) coupled or linked and does not exclude the presence of intermediate elements between the coupled or associated items absent specific contrary language.

In some examples, values, procedures, or apparatus may be referred to as “lowest,” “best,” “minimum,” or the like. It will be appreciated that such descriptions are intended to indicate that a selection among many alternatives can be made, and such selections need not be better or otherwise preferable to other selections.

In the description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

Unless otherwise indicated, all numbers expressing quantities of components, dimensions, forces, moments, percentages, temperatures, times, and so forth, as used in the specification or claims are to be understood as being modified by the term “about.” Accordingly, unless otherwise indicated, implicitly or explicitly, the numerical parameters set forth are approximations that can depend on the desired properties sought and/or limits of detection under test conditions/methods familiar to those of ordinary skill in the art. When directly and explicitly distinguishing embodiments from discussed prior art, the embodiment numbers are not approximates unless the word “about” is recited.

Although there are alternatives for various components, parameters, operating conditions, etc., set forth herein, that does not mean that those alternatives are necessarily equivalent and/or perform equally well. Nor does it mean that the alternatives are listed in a preferred order unless stated otherwise.

As used herein, the terms “substantially free of adhesive” and “substantially adhesive-free” mean that there is 50% or less, such as 30% or less, 20% or less, 10% or less, or 5% or less, of the quantity of adhesive as in zones where the application of adhesive is specified. The term “adhesive-free” includes the term “substantially adhesive-free.”

The term “substantially parallel” means an angle of +10° between an object and a reference. The term “substantially perpendicular” means an angle of 80° to 100° between an object and a reference.

### Overview of the Disclosed Technology

Certain examples of the present disclosure pertain to shipping mailers made from corrugated paperboard materials such as single face corrugated material comprising a liner layer and a fluted medium layer. In certain examples a shipping mailer can include a one-piece main body folded about a center fold line or hinge line to provide the first and second walls. The shipping mailer can have first and second side portions (e.g., parallel or curved side portions) or edges extending between first and second end portions (e.g., parallel or curved end portions) or edges (also referred to as top and bottom end portions or edges) such that the shipping mailer has a quadrilateral outline, at least in the collapsed state. In certain embodiments, the first end portion can be closed, and the second end portion can comprise an opening. In certain embodiments, the opening can extend along a first axis (e.g., the x-axis) between the side portions, although other configurations are possible. The side portions can be longer than the end portions, the same length as the end portions, or shorter than the end portions.

The opening of the shipping mailer can be closable by a closure to seal the interior of the shipping mailer. In certain examples, the closure can be configured as an end closure such as a flap extending from one wall (e.g., the second wall) and configured to be folded over the opening and secured to the other wall in the manner of an envelope. In certain examples, the first and second walls can be coupled together, secured, or adhered to form a closure without a flap or other end closure member. In certain examples, the first and second walls can have the same or similar length, and tape can be applied (e.g., to the exteriors of the walls) to join the walls and close the shipping mailer. In certain embodiments, the closures can comprise adhesive, fasteners, hot melt adhesive, glue, or other securing means for securing the first wall to the second wall at the closure when the shipping mailer is in a closed state. In certain examples, the adhesive can be a co-adhesive. For example, co-adhesive can be located on the inside surface of the flap, and on the corresponding flap-receiving area of the other wall (e.g., the first wall) such that the flap and the flap-receiving area are bonded together upon contact to seal the shipping mailer. Adhesive covered by a removable, peelable, or releasable liner strip can also be used on the flap and/or on the flap-receiving surface of the first wall.

In some examples the fluted medium layer can comprise one or more fold lines comprising creases, folds, cuts, cutouts, scores, buckled and/or crushed areas, weakened areas or lines of weakness (e.g., thinned areas or lines), etc., that facilitate folding the flutes (and thereby the walls), and/or expanding the pouch to receive an article. The fold lines can be straight or curved. In certain examples, the peaks of the flutes can comprise indentations or deformations axially aligned with each other to form a plurality of straight longitudinal creases (also referred to as longitudinally-extending fold lines and longitudinal fold lines). In examples in which the flutes extend along the x-axis (e.g., between the side portions), the flutes can comprise longitudinal fold lines/creases extending along the y-axis (e.g., the fold lines/creases can extend between the end portions of the shipping mailer/envelope). The corrugations can comprise multiple longitudinal fold lines (e.g., 2, 3, 4, 5, 6, 7, 8, or more longitudinal fold lines) spaced apart or offset laterally (e.g., along the x-axis) from each other between the side portions. The spacing can be equal, unequal, or graduated (e.g., increasing or decreasing from one side of the shipping mailer/envelope to the other), or variable, or in a pattern. The longitudinal fold lines on the first and second walls can be aligned or offset from each other on the inside of the pouch. The longitudinal fold lines can facilitate bending/buckling/folding of the corrugations about axes perpendicular to the corrugations, and the outward expansion of the walls by formation of ridges or apices in the exterior surfaces of the walls to accommodate objects received in the shipping mailer. The longitudinal fold lines can also extend at an angle to the longitudinal axes of the corrugations.

In examples that comprise areas where the flutes are crushed and/or flattened (also referred to as being “crimped”), the edges (e.g., boundaries) of the crushed areas can behave similarly to fold lines created in other ways such as by scoring or creasing the flutes. For example, the boundary between portions of flutes that are intact and portions of flutes that are crushed can induce the walls of the shipping mailer to fold along the boundary in the same manner as other kinds of fold lines described herein. Accordingly, as used herein, the boundary of an area in which the flutes are crushed is within the scope of the term “fold line.”

The flutes can also include curved fold lines comprising creases, folds, cutouts, scores, indentations, buckled and/or crushed areas, etc. In certain embodiments, the curved fold lines can be located proximate the center fold line or hinge line separating the first wall from the second wall. In certain embodiments, each of the first wall and the second wall can comprise a curved fold line in the flutes. The curved fold line can extend generally between the parallel side portions of the shipping mailer. In certain embodiments, the curved fold lines can extend from and return to the center fold line from which the first and second walls extend such that an apex of each respective curved fold line is offset from the center fold line (e.g., from the closed first end portion of the shipping mailer) toward the second end portion of the shipping mailer. In certain examples, the curved fold lines can be semi-circular and can comprise radii. In certain examples, the curved fold lines can be described by a portion of a period (e.g., half) of a sine wave. In certain examples, the flutes of each wall can be configured to bend or flex about the curved fold lines to create concave, flat, or convex surfaces at various locations on the shipping mailer. For example, the walls can flex about the curved fold lines such that a flat or a concave bottom end surface/end wall can be formed in the shipping mailer extending between the first and second walls at the closed first end portion of the shipping mailer opposite the opening. This can facilitate the receipt of relatively large objects in the shipping mailer. In certain examples, the distance of the apices of the curved fold lines from the center fold line can determine the width of the end surface (and thereby the thickness of the object that can be accommodated in the shipping mailer).

The shipping mailer can comprise one or a plurality of zones in which the liner layer and the fluted medium layer are adhered to each other, and one or a plurality of zones in which the liner layer and the fluted medium layer are not adhered to each other. In some examples, the adhesive-free zones can be bounded on both longitudinal edges by zones comprising adhesive. In the adhesive-free zones, the liner layer and the fluted medium layer can move relative to each other, allowing the shipping mailer to flex or deform to accommodate an article inserted into the shipping mailer.

Certain examples of the disclosure also pertain to shipping mailers including perforated tear-off strips. The perforated tear-off strips can comprise perforations formed in both the first wall and in the second wall. The perforations of the first wall can be aligned with the perforations of the second wall, or offset to varying degrees. Pulling the tear-off strip can cause the tear-off strip to separate from the body of the shipping mailer along the perforations to create an opening in the shipping mailer to access the interior.

Certain examples of the disclosure also pertain to systems and methods of producing single face web materials in which one or a plurality of adhesive-free zones are formed on the fluted medium at locations that are spaced inwardly from the outer edges of the fluted medium. Portions of the fluted medium at the locations of the adhesive-free zones are then removed in a continuous cutting process to form single face web that has a plurality of regions of fluted medium adhered to a continuous liner sheet. Stated differently, the resulting single face web has longitudinally-extending zones of fluted medium separated by one or a plurality of longitudinally-extending zones comprising only the liner layer. Cutting the single face web longitudinally (e.g., in the direction of motion through the corrugator) along the liner layer zones can produce a plurality of product streams or “outs.” Each product stream can include a fluted medium layer and a liner layer that extends beyond the fluted medium on both longitudinal edges, known as “edged single face.” The systems and methods described herein thus advantageously provide for the efficient production of multiple streams of edged single face product using standard widths of liner and medium while reducing waste. This can be advantageous for larger flute sizes. The systems and methods described herein are also applicable to producing edged corrugated material comprising a liner, a fluted/corrugated medium, and a second liner, in which one of the liner layers includes a fin extending beyond the edge of the fluted medium.

In some examples, the shipping mailers described herein can comprise a one-piece body made of single face corrugated material in which the flutes of the first wall and the second wall are nested together on the inside of the shipping mailer when the shipping mailer is in an unfilled/unstuffed state. The first and second walls can be secured together along sealed side edge portions of the shipping mailer to form a pouch. In some examples, the sealed side edge portions can comprise adhesive. The shipping mailer can be made from single face corrugated material in which the flutes of the fluted medium layer extend to the edges of the liner layer, or from edged single face corrugated material in which the liner layer extends beyond the edges of the fluted medium layer.

The shipping mailers described herein can comprise longitudinal fold lines formed in the first wall and in the second wall that extend from the closed first end portion of the shipping mailer to the second end portion proximate the opening. In some examples, the longitudinal fold lines are offset inwardly from side edges of the shipping mailer. In some examples, the longitudinal fold lines can be located inwardly of the sealed side edge portions of the shipping mailer. In some examples, the longitudinal fold lines can be scores formed in the flutes of the single face corrugated material. In some examples, the flutes of the single face corrugated material can be crushed in the sealed side edge portions. In some examples, the nested flutes of the first and second walls can interlock when crushed. In some examples, the longitudinal fold lines can be the boundary between the intact flutes in the interior of the pouch and the crushed flutes in the sealed side edge portions. In some examples, the fluted medium layer can include fold lines near the crushed flutes of the sealed side edge portions but spaced inwardly from the crushed flutes (e.g., by 1 mm to 10 mm, such as 1 mm to 5 mm). The longitudinal fold lines can induce the first and second walls to fold about the longitudinal fold lines proximate the sealed side edge portions to relieve stress on the sealed side edge portions.

In some examples, the shipping mailer can comprise curved fold lines. In some examples, the curved fold lines can originate from and return to the center fold line from which the first and second walls extend. In some examples, the first and second walls can fold along the curved fold lines to form a concave end surface when a product is inserted into the shipping mailer. In some examples, curved fold lines can extend upwardly from at or near the closed first end portion toward the second end portion and can have a concavity that is oriented toward the nearest sealed side edge portion of the shipping mailer. In some examples, the curved fold lines can originate from the center fold line, or can be spaced upwardly from the center fold line in a direction toward the second end portion.

The disclosed shipping mailers can include any of the features described above and/or described in the examples below in any combination.

### Example 1: Systems and Methods of Producing Edged Single Face Corrugated Material

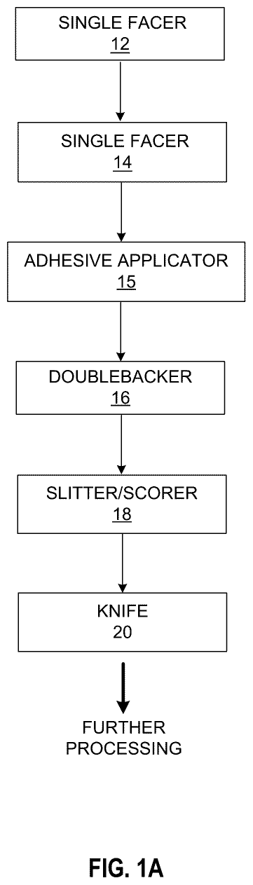

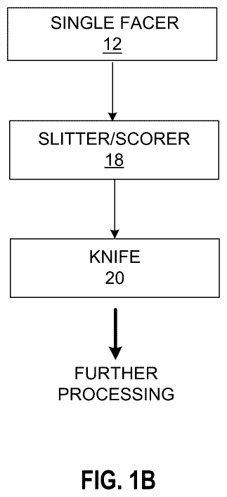

A typical corrugator can include a series of machines and/or systems that form, adhere, and/or cut a variety of paper and/or paperboard materials to produce corrugated board and related products. FIG. 1A is a schematic block diagram of a representative example of a corrugator 10. The corrugator 10 can include one or a plurality of single facer machines, referred to herein as “single facers” and “single facer systems.” Single facer systems include a plurality of rollers that form corrugations (also referred to as “flutes”) in a first paper input material, typically a containerboard material referred to hereinafter as “medium” or “corrugating medium.” Once the flutes are formed in the medium, the fluted medium is adhered to a second paper input material, typically a paperboard liner referred to hereinafter as “liner.” The resulting combination of fluted medium and adhered liner is known as “single face web” or “single face.”

A typical corrugator can include one, two, or more single facer systems, depending upon the particular product to be produced. The illustrated example corrugator 10 includes two single facers 12 and 14 that can supply single face web individually or simultaneously to an adhesive applicator machine 15, which can apply adhesive to the flute tips of the corrugated medium opposite the first liner layer. The single face web can then proceed to a doublebacker machine 16. The doublebacker machine 16 can apply a second liner to the opposite face of the single face web to form “single wall” corrugated board (e.g., corrugated board comprising a fluted medium between two liner layers). Streams of single face web from both the single facer system 12 and the single facer system 14 can also be combined in the doublebacker to form “double wall” corrugated board, comprising a liner, a first corrugated medium, a second liner, a second corrugated medium, and a third liner. In some examples, the corrugator can also include a triple stack machine comprising a plurality of adhesive applicators. The triple stack machine can be part of the doublebacker 16, or a standalone system.

The corrugated board produced in the doublebacker 16 can then proceed to a slitter/scorer machine 18. The slitter/scorer machine 18 can, for example, slit or cut the corrugated board into multiple parallel streams (also referred to as “outs”). The product streams can have specified dimensions (e.g., specified width dimensions measured perpendicular to the direction of flow through the corrugator). The slitter/scorer 18 can also score the corrugated board at specified locations.

The knife (also referred to as a cutoff knife) 20 can cut the corrugated board stream(s) received from the slitter/scorer 18 to specified dimensions for a particular product. The cut corrugated board can then proceed to subsequent machines for further processing.

FIG. 1B shows another configuration of a corrugator 10 set up for producing single face web for use in manufacturing, for example, envelopes, shipping mailers, and the like. The corrugator 10 in FIG. 1B can include a single facer 12, a slitter/scorer 18, and a knife 20, although other configurations are possible depending on the particular product to be manufactured.

In the production of certain packaging products such as mailers, envelopes, etc., it can be advantageous to produce single face web in which the liner extends laterally beyond the corrugated medium, known as edged single face. The portion of the liner that extends beyond the corrugated medium is known as a “fin.” Such fins can facilitate, for example, face-to-face sealing between liner surfaces when two lengths of edged single face are brought together. Edged corrugated material can also be used to produce single wall or double wall corrugated board in which the liner fins of the edged corrugated material are folded over to seal the exposed edges of the flutes, known as closed-edge corrugated.

In the U.S., medium and liner materials can be provided in widths corresponding to the width of a manufacturer's corrugating machinery. Typical widths are 48 inches (123 cm) or greater, and can be as large as 120 inches (305 cm) etc. Single face and/or corrugated board produced at such widths typically can be divided (e.g., cut) into multiple parallel streams or “outs,” as described above. Thus, in one particular example, a 48 inch (123 cm) wide fluted medium layer combined with a 48 inch (123 cm) wide liner layer to produce a 48 inch (123 cm) wide single face web can be divided into four product streams or “outs” each having a width of 12 inches (30.5 cm). However, conventional corrugator machinery and processes are unable to produce edged single face except at the outermost edges of a single face web, such as by running medium having a width that is less than the liner width. Thus, producing edged single face often requires reconfiguring the corrugator to run liner and medium widths corresponding to the dimensions of the specific product to be produced, which are often significantly narrower than the widths that typical corrugator equipment can efficiently handle. This can dramatically reduce efficiency because only a single product stream can be run, and also typically results in significant waste due to the mismatch between the standard feed paper sizes and the product dimensions.

Thus, it can be advantageous to remove one or a plurality of sections of the fluted medium layer from a single face web produced in a typical width in the single facer system. The resulting single face web thus includes one or a plurality of longitudinally-extending zones in which the corrugated medium has been removed. The longitudinally-extending zones can be located inwardly of the outer edges of the single face web toward the central axis. This allows the single face web to be cut into multiple product streams or “outs” across its width, wherein each of the product streams is edged single face.

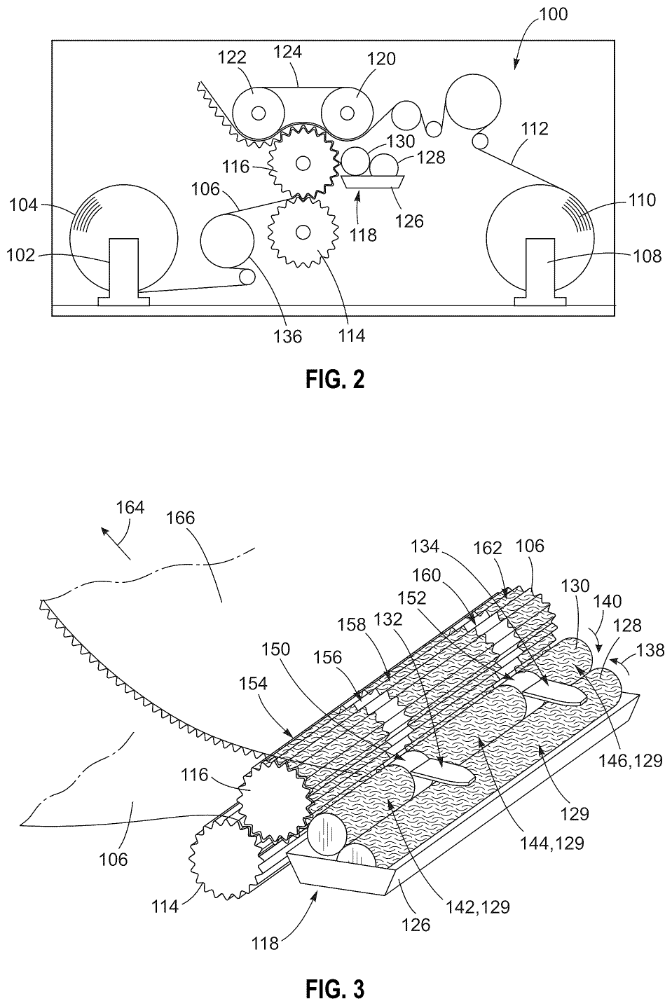

For example, FIG. 2 illustrates a representative example of a single facer system 100. The single facer system can include a first roll stand 102 configured to mount a roll 104 of containerboard medium 106. The single facer system can further include a second roll stand 108 configured to mount a roll 110 of containerboard liner 112. The single facer system has a pair of corrugating rollers 114 and 116. The corrugating rollers 114 and 116 include a plurality of complementary ridges that interdigitate when the rollers are contra-rotated. The single facer system further comprises an adhesive applicator system generally indicated at 118, and a plurality of pressure rollers 120, 122. In the illustrated configuration, a belt 124 extends around the pressure rollers 120 and 122 and is driven by the pressure rollers.

In the illustrated example, the adhesive applicator system 118 includes an adhesive reservoir 126 (also known as a pan), a pickup roller 128, and an applicator roller 130. The pickup roller 128 is positioned in the adhesive reservoir 126. The applicator roller 130 is positioned adjacent the pickup roller 128 and can be in contact with the pickup roller 128, or spaced at a specified distance from the pickup roller 128 such that adhesive is transferred from the pickup roller to the applicator roller in a controlled manner. For example, the pickup roller 128 and the applicator roller 130 can be spaced by 0.005 inch to 0.020 inch (0.127 mm to 0.508 mm).

The adhesive applicator system 118 can be configured to selectively apply and/or remove adhesive from selected zones on the surface of the applicator roller 130. In certain examples, the adhesive applicator system 118 can further comprise one or a plurality of adhesive removers. For example, in the configuration shown in FIG. 3, the adhesive applicator system 118 includes two adhesive removers 132 and 134. The removers 132 and 134 can be configured as paddles, wipers, blades, doctor blades, squeegees, etc. The adhesive removers 132 and 134 are spaced apart from each other, and are also spaced inwardly from the ends of the applicator roller 130. In certain examples, the adhesive removers 132 and 134 can be mounted on a support, and can be positionable relative to the applicator roller 130 and/or relative to each other. The adhesive removers 132 and 134 can be brought into contact with the applicator roller 130.

In operation, medium 106 can be drawn from the roll 104, around a plurality of rollers 136 (e.g., heater rollers), and through the corrugating rollers 114 and 116. The corrugating rollers 114, 116 can form flutes in the medium 106, and the resulting fluted medium can travel around the corrugating roller 116 toward the adhesive applicator system 118. The pickup roller 128 can be positioned at least partially in an adhesive bath contained in the reservoir 126. Rotation of the pickup roller 128 in the adhesive bath (e.g., in the direction of arrow 138 in FIG. 3) can coat the surface of the pickup roller 128 with adhesive 129. The pickup roller 128 can transfer adhesive 129 to the surface of the applicator roller 130, which can rotate in the direction indicated by arrow 140 (FIG. 3).

The adhesive removers 132 and 134 can be positioned in contact with the applicator roller 130, and can remove and/or wipe adhesive 129 from selected portions of the applicator roller 130 as it rotates past the removers. Thus, the applicator roller 130 can have a plurality of zones on its surface that are coated with adhesive, and one or a plurality of zones that are free and/or substantially free of adhesive. This distribution of adhesive can be transferred to the flute tips of the fluted medium 106 on the corrugator roller 116 as the applicator roller 130 rotates in contact with the fluted medium. The fluted medium 106 can thus comprise a plurality of zones which have adhesive, and one or a plurality of zones that are free and/or substantially free of adhesive. These zones are referred to hereinafter as “adhesive free,” and it should be understood that the term “adhesive free” includes the term “substantially adhesive-free.”

For example, in the configuration illustrated in FIG. 3 the applicator roller 130 can comprise regions or zones 142, 144, and 146 which comprise adhesive 129. The applicator roller 130 can further comprise regions or zones 150 and 152 that are free of adhesive (e.g., due to the wiping action of the removers 132 and 134). This adhesive distribution can be transferred to the flute tips of the fluted medium 106 on the corrugating roller 116 such that the fluted medium comprises a plurality of first zones (also referred to as “stripes”) comprising adhesive and one or a plurality of second zones (also referred to as “stripes”) that are adhesive-free. The fluted medium 106 can thus comprise a first zone 154 comprising adhesive 129, a second zone 156 that is free of adhesive, a first zone 158 comprising adhesive 129, a second zone 160 that is free of adhesive, and a first zone 162 comprising adhesive 129. The two adhesive-free second zones 156 and 160 can both be spaced inwardly away from the outer edges of the fluted medium 106 toward the central axis of the medium. In the illustrated configuration, each of the adhesive-free second zones 156 and 160 are bounded on both sides by a first zone comprising adhesive. Each of the first zones 154, 158, and 162 comprising adhesive and each of the adhesive-free second zones 156 and 160 can extend continuously along the fluted medium in the direction of motion through the single facer, which is indicated by arrow 164.

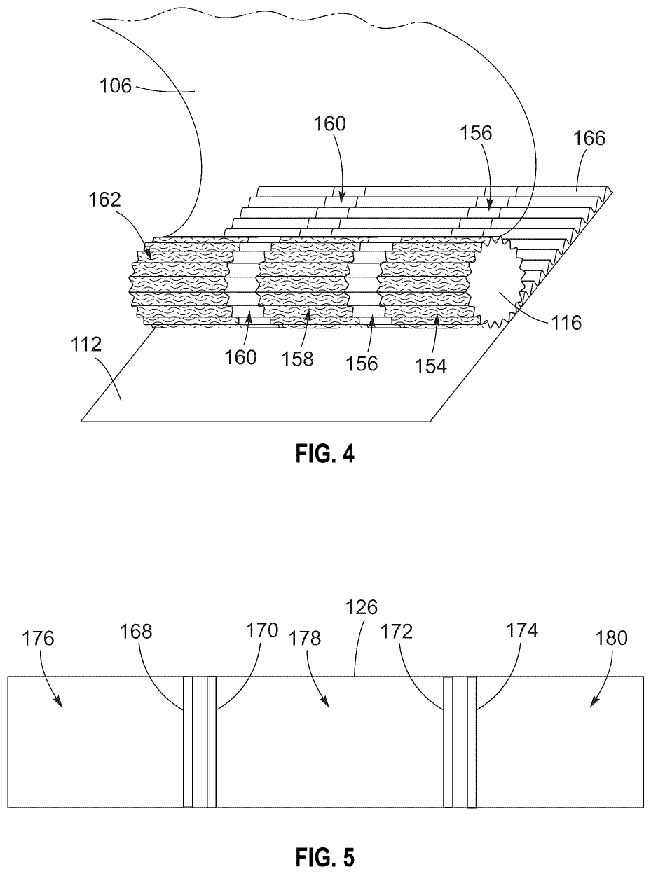

Following application of adhesive to the fluted medium 106, the liner 112 is applied to the fluted medium by the pressure rollers 120 and 122, and the belt 124 (FIG. 2). Thus, in the resulting single face web 166, the liner 112 is adhered to the fluted medium primarily along, or only along, the first zones 154, 158, and 162 that comprise adhesive 129. FIG. 4 illustrates this concept with the medium 106, the liner 112, and the corrugating roller 116 shown in isolation for purposes of illustration. The pressure rollers can also be configured in other ways, including one or a plurality of pressure rollers that are sized and positioned to contact the web directly.

It should be understood that the number of adhesive removers, and their position along the width of the applicator roller 130 can be varied depending upon, for example, the particular product to be produced.

The adhesive-free second zones can be produced in a variety of ways. For example, in another embodiment the adhesive reservoir 126 can include a plurality of dam members. The dams can be positionable within the reservoir 126 to control the size of the adhesive bath (e.g., relative to the adhesive rollers). For example, the dams can be offset from the side walls of the reservoir 126 to provide an adhesive bath that extends across less than the full width of the reservoir. Dams can also be positioned in the reservoir 126 to provide a plurality of adhesive baths that are separated across the width of the reservoir by gaps where there is no adhesive. FIG. 5 is a top plan view of a reservoir 126 including a first set of dams 168 and 170, and a second set of dams 172 and 174. By filling the volumes 176, 178, and 180 with adhesive, adhesive baths can be formed that are spaced apart along the length of the reservoir 126. By leaving the space between the dams 168 and 170 and the space between the dams 172 and 174 free of adhesive, zones of adhesive and adhesive-free zones similar to those shown in FIGS. 2-4 can be formed on the fluted medium. Alternatively, the plurality of adhesive baths can be in a plurality of separate reservoirs.

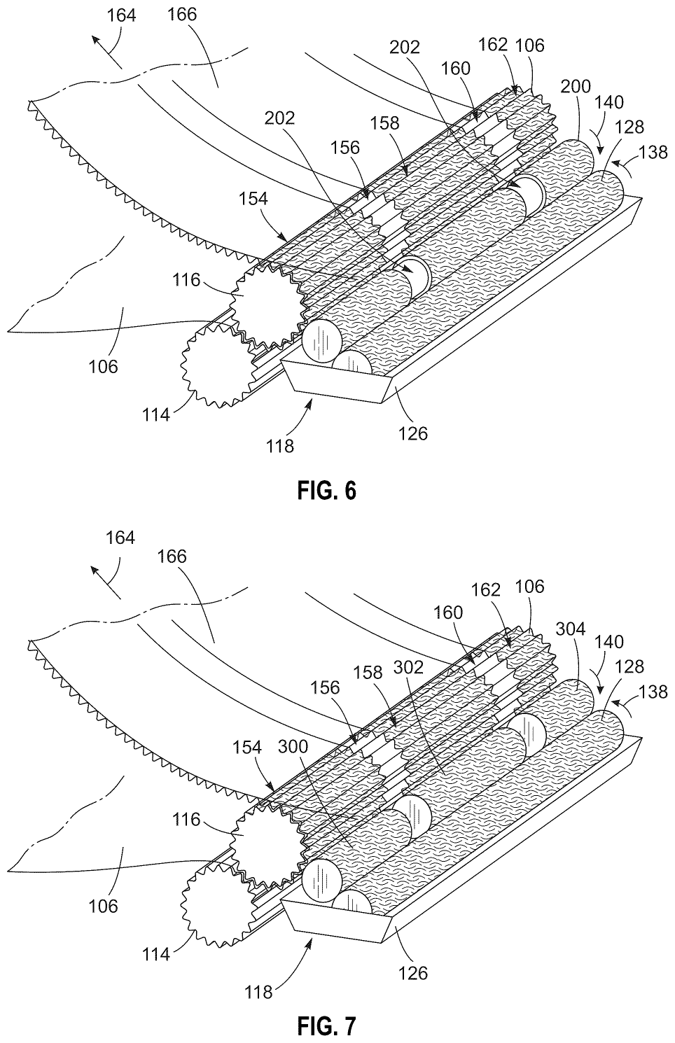

In yet another example, the applicator roller can have grooves machined into its surface with widths corresponding to the specified width of adhesive-free second zones to be formed on the fluted medium. Such an applicator roller 200 is illustrated in FIG. 6. The recessed surfaces of the grooves 202 do not receive adhesive from the pickup roller 128, and also do not contact the fluted medium, resulting in the illustrated pattern of adhesive-containing first zones 154, 158, 162 and adhesive-free second zones 156, 160 on the fluted medium.

In yet another example, the applicator roller can comprise a plurality of separate rollers in contact with the pickup roller 128 (or separate pickup rollers). The applicator rollers can be spaced apart at distances corresponding to selected width(s) of the adhesive-free zones to be produced on the fluted medium. For example, FIG. 7 illustrates a system with three applicator rollers 300, 302, and 304 spaced apart such that the rollers produce the previously described arrangement of adhesive-containing first zones and adhesive-free second zones on the fluted medium. Adhesive removers, grooved applicator rollers, and/or separate applicator rollers can also be implemented in any combination to form adhesive-free zones on the fluted medium. Adhesive also not need to be applied to the fluted medium using an applicator roller. For example, adhesive can be sprayed onto the fluted medium using a plurality if spray heads that form the adhesive zones and the adhesive-free zones on the fluted medium.

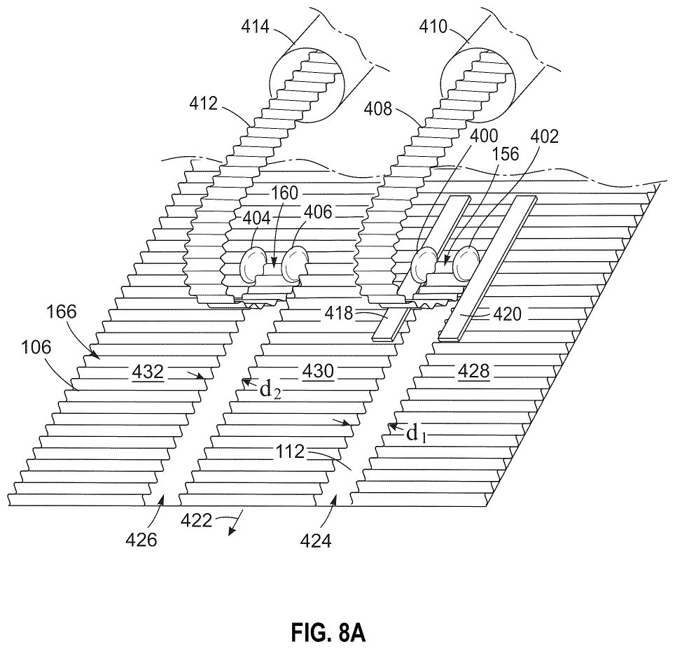

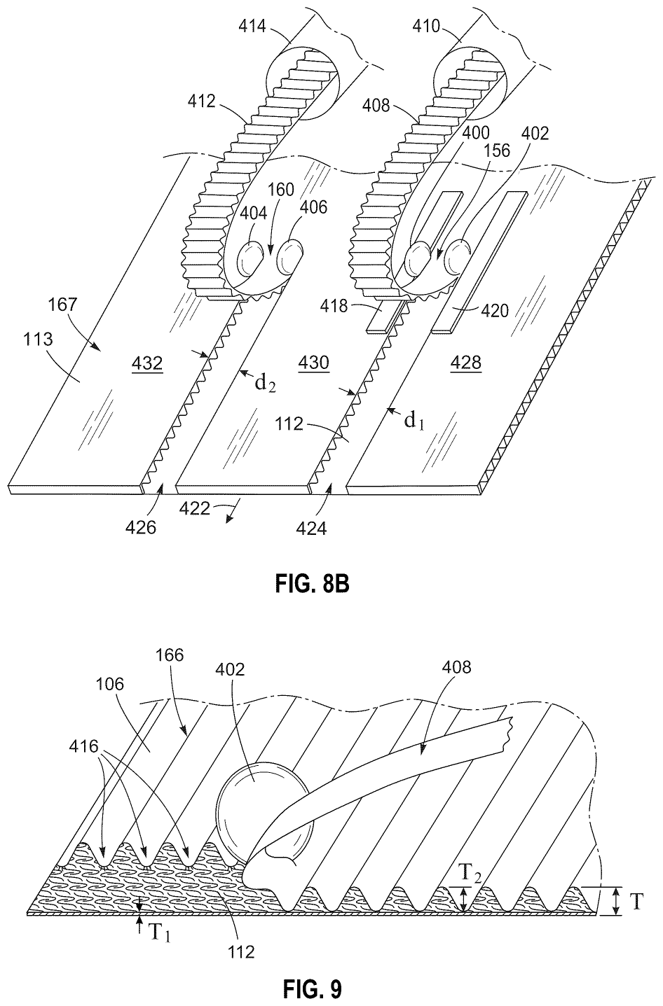

After the liner is adhered to the fluted medium, the single face web 166 can proceed to the slitter/scorer machine 16 (FIGS. 1A, 1B). The slitter/scorer 16 can be equipped with one or a plurality of blade assemblies comprising pairs of blades. Each pair of blades can be aligned with an adhesive-free second zone of the single face web 166 (e.g., of the fluted medium in particular). The blades can be spaced apart by a specified distance corresponding to a width dimension of the adhesive-free second zone. FIG. 8A illustrates a representative example of the single face web 166 traveling through a slitter/scorer including a first set of blades 400 and 402 aligned with the adhesive-free second zone 156. The blades 400 and 402 can be spaced apart by a distance d₁, which can be equal or substantially equal to the width of the adhesive-free second zone 156. A second set of blades 404 and 406 are shown aligned with the adhesive-free second zone 160 and spaced apart by a distance d₂, which can be equal or substantially equal to the width of the adhesive-free second zone 160.

In certain examples, the adhesive-free second zones 156 and/or 160 can be removed from the fluted medium. For example, as the single face web 166 travels past the blades 400-406, the blades 400 and 402 can cut a continuous strip 408 from the fluted medium 106 at the location of the adhesive-free second zone 156. The strip 408 can have a width approximately equal to d₁. Because the width of the strip 408 is equal or substantially to the width of the adhesive-free second zone 156, the strip 408 can be easily separated from the liner 112 and removed in a continuous manner by, for example, suction. In FIG. 8A, for example, the strip 408 is shown being drawn away from the single face web by a vacuum hose 410. The blades 404 and 406 can cut a second continuous strip 412 from the fluted medium 106 at the location of the adhesive-free second zone 160, and having a width equal or substantially equal to the width of the adhesive-free zone 160. The strip 412 is shown being drawn away by a vacuum hose 414, although other removal techniques are possible.

Referring to FIGS. 8A and 9, the height of the blades 400-406 can be precisely controlled such that the blades slice or cut through the fluted medium 106, but do not cut through the liner 112. FIG. 9 shows the blade 402 in isolation. The overall thickness T of the single face web 166 can be the sum of the thickness T₁ of the liner 112 and the thickness or height T₂ of the fluted medium 106. In certain examples, the blades 400-406 can be positioned relative to an anvil or other structure beneath the single face web. In certain examples, the blades 400-406 can be set at a height above the anvil that is equal or substantially equal to the thickness T₁ of the liner 112 (e.g., taking into account a standard deviation of the thickness T₁). Thus, the blades can be positioned to cut through substantially the entire thickness T₂ of the fluted medium 106, while leaving the liner layer 112 intact or substantially intact. In certain examples, the blades can be positioned to cut through 90% or more of the thickness T₂ of the fluted medium, such as 95% or more, 90% to 100%, 95% to 100%, etc., of the thickness T₂ of the fluted medium. In yet other examples, the blades 400-406 can be positioned to cut through the entire thickness T₂ of the fluted medium 106 plus a small percentage of the thickness T₁ of the liner 112. For example, the blades can be positioned to cut through the entire thickness T₂ of the fluted medium 106 plus 1% to 10%, 1%, to 5%, etc., of the thickness T₁ of the liner 112. Stated differently, the slits cut by the blades 400-406 are “partial depth” slits through a portion of the depth of the single face web.

In certain examples, the thickness T₂ of the fluted medium 106 and/or the thickness T₁ of the liner 112 can vary within specified tolerances. Thus, in certain examples, as the single face web passes through the blades 400-406, the blades can occasionally cut through less than the full thickness T₂ of the fluted medium 106. This can leave the flutes of the strips 408 and/or 412 connected to the main body of the fluted medium at relatively small, thin attachments, referred to as lans 416. In such instances, the lans 416 can be torn as the strips 408/412 are separated from the fluted medium layer by the force of the vacuum hoses.

To prevent off-axis tears of the fluted medium, the pairs of blades can comprise a set of guides positioned outward of the blades. FIG. 8A illustrates the blades 400 and 402 positioned between a representative pair of guides 418 and 420. The guides 418 and 420 can contact the fluted medium 106, and can arrest and/or prevent tears of the fluted medium in directions other than the direction of travel of the single face web, indicated by arrow 422. In certain examples, the blades 400-406 can be positioned to cut the fluted medium leaving the lans 416. In certain embodiments, the blades 400-406 can cut completely through the fluted medium and slightly score the liner (e.g., without affecting its structural strength) due to the thickness variation noted above.

A plow or other mechanical device can be used to initiate the removal of the strips 408/412 into the vacuum hoses, and/or to restart the removal process in the event of a break in a strip.

After removal of the strips 408 and 412 (e.g., the adhesive-free second zones 156 and 160), the single face web can comprise corresponding gaps 424 and 426 in the fluted medium 106 between sections 428, 430, and 432 of fluted medium. The portions of the liner 112 extending across the gaps 424 and 426 can become the extended edges or fins of the edged single face product once the single face web is cut into separate product streams.

The single face web can be cut into separate product streams or “outs” of specified width further downstream in the slitter/scorer 18, and/or in the knife 20 (FIGS. 1A and 1B). In the example of FIG. 8A, the single face web can be divided and/or cut into three product streams, such as by cutting the liner 112 in the gaps 424, 426 parallel to the direction of travel. In certain examples, the liner 112 can extend beyond the outermost edges of the fluted medium 106, and/or the outermost edges of the fluted medium can be trimmed to create liner fins at the outermost edges of the single face web. Because the adhesive-free second zones (e.g., strips 408 and 412) have been removed from the fluted medium at locations offset inwardly from the outer edges of the medium, the three resulting product streams can each comprise edged single face with liner fins on both sides of the fluted medium. The separated product streams can then proceed to a cutoff knife, which can be part of the knife 20 of FIGS. 1A and 1B. At the cutoff knife, the product streams can be cut into blanks for a specified product, such as mailers, envelopes, containers, boxes, etc.

FIG. 8B illustrates a corrugated web 167 (e.g., a fluted medium 106 between two liners 112 and 113) traveling through a slitter/scorer. With reference to FIG. 8B, when producing edged corrugated material the blades can cut through a liner layer (e.g., the upward-facing second liner 113) and through the fluted medium 106, and can leave the first liner layer 112 intact or substantially intact. The resulting strip of material comprising a portion of the second liner 113 and a portion of the fluted medium 106 can be removed as described above. The corrugated web can then be cut in the gaps 424 and 426 to produce a plurality of product streams of edged corrugated material, which can be used to create packaging products such as closed edge corrugated containers.

It should be understood that the examples above are not intended to be limiting, and that the disclosed technology can be implemented in a variety of ways. For example, the single facer systems described herein can be configured to apply adhesive to the fluted medium in any specified manner, for example, with any specified number of adhesive-free zones having any specified width and location. The slitter/scorer can also comprise any number of pairs of blades having any specified spacing. Additionally, it should be understood that the above processes can be applicable to double-faced corrugated board in addition to single face. The amount of adhesive in the second zones of the fluted medium (e.g., the zones to be removed) can also be reduced as compared to the zones where bonding between the medium and the liner is specified. For example, the amount of adhesive in the second zones can be such that any bond between the fluted medium and the liner in the second zones can be easily broken during removal. Even 50% of the specified quantity of adhesive applied in the first zones or more, such as 70%, can result in a weakened bond that can be broken during removal of the second zones.

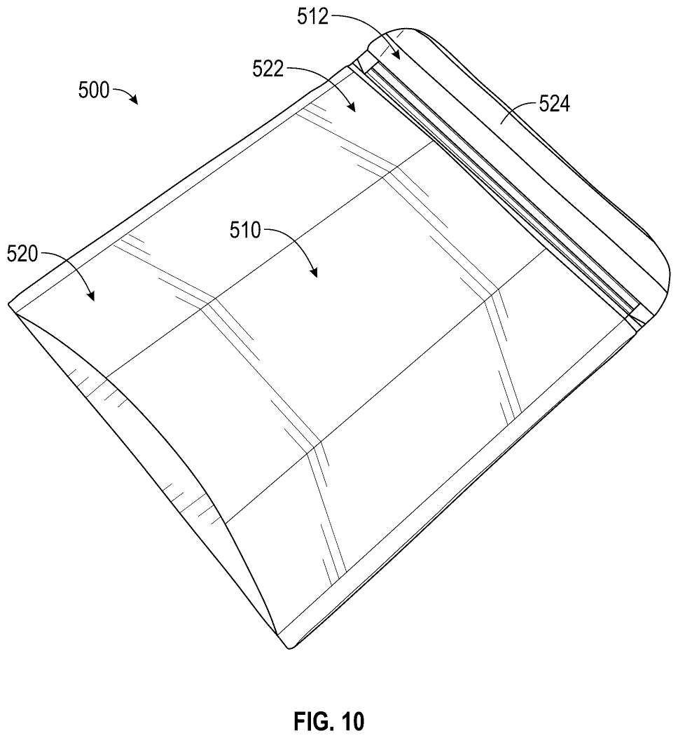

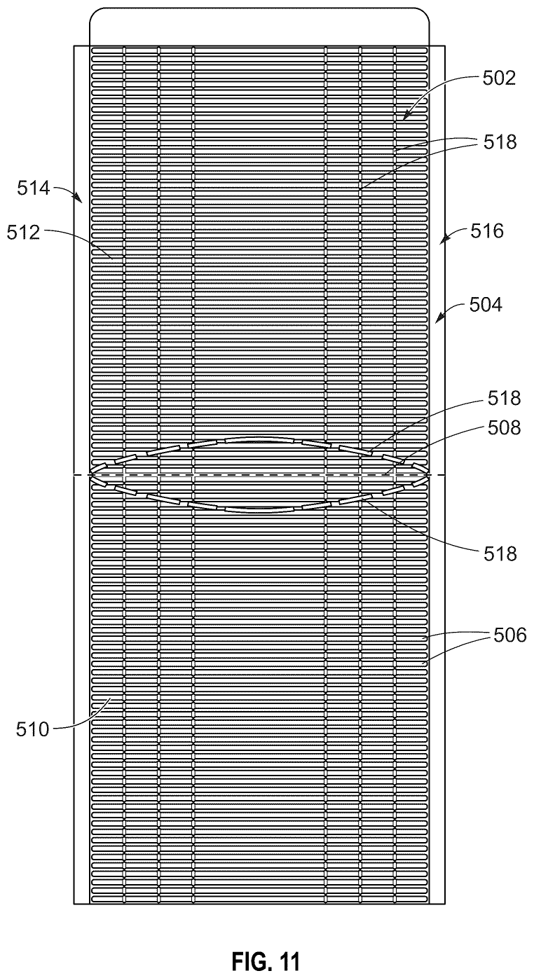

Examples of products that can be made using the edged single face produced by the systems and methods described herein can include shipping mailers and/or envelopes, such as the exemplary shipping mailer 500 shown in FIGS. 10 and 11. FIG. 10 illustrates the shipping mailer 500 in an assembled, unstuffed state. FIG. 11 illustrates the shipping mailer 500 in a laid-flat state (also referred to as a blank) before the walls are folded together to form the pouch. The shipping mailer 500 can be made from edged single face material comprising a fluted medium layer 502 and a liner layer 504, as described above. The liner layer 504 can extend beyond both edges of the fluted medium layer 502 in the longitudinal direction (e.g., perpendicular to the direction of the flutes 506). A fold line 508 can extend across the blank in the direction of the flutes. The portion of the blank below the fold line 508 can be folded up about the fold line 508 to form a first wall 510, and the portion above the fold line can form a second wall 512. The walls 510 and 512 of the shipping mailer can be secured together along the finned edges 514, 516 of the edged single face material (e.g., by adhesive). A variety of curved and/or longitudinally extending fold lines 518 can be formed in the flutes of the fluted medium layer to allow the shipping mailer to fold and conform to an object inserted into the shipping mailer. Additional details of the shipping mailer 500 can be found in U.S. patent application Ser. No. 16/945,333, which is incorporated herein by reference in its entirety. Referring to FIG. 10, in the assembled state the shipping mailer can comprise a closed first end portion 520 and a second end portion 522. The first and second walls 510, 512 can at least partially define an interior of the shipping mailer. The second end portion 522 can comprising an opening into an interior of the shipping mailer. The opening can be scalable by a closure, such as a closure flap 524 of the second wall 512 that can be folded over and adhered to the first wall 510.

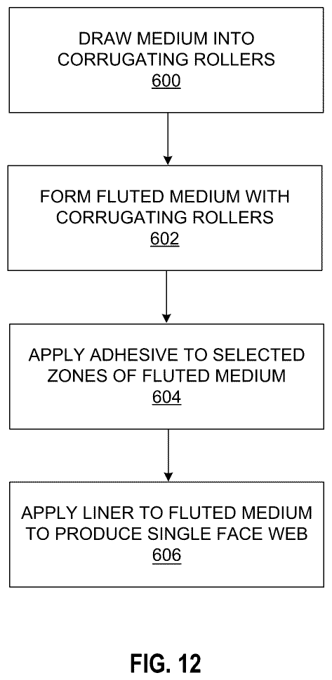

FIG. 12 illustrates a representative method of producing a single face web in which the fluted medium comprises one or a plurality of adhesive-free zones. At process block 600, medium is drawn from a roll of medium into a pair of corrugating rollers in a single facer system. At process block 602, flutes are formed in the medium with the corrugating rollers to produce fluted medium. At process block 604, adhesive is applied to flute tips of the fluted medium in selected zones such that in a downstream direction from the corrugating rollers, the fluted medium comprises a plurality of first zones comprising adhesive and a second zone that is adhesive-free, and which is offset inwardly away from the outer edges of the fluted medium. At process block 606, liner is applied to the corrugated medium to produce single face web. Thus, in certain examples the liner is not adhered, or is minimally adhered, to the flute tips of the fluted medium in the adhesive-free zones. In certain examples, the adhesive-free zones of the fluted medium can be spaced inwardly from the outer edges of the fluted medium toward the center of the fluted medium relative to the direction of travel through the single facer.

Any or all of the examples described above can provide a number of significant advantages over existing systems and methods of producing edged single face and edged corrugated. For example, the formation of adhesive-free zones spaced away from the edges of the fluted medium toward the center of the fluted medium, and the ability to remove those adhesive-free zones using the single facer systems, slitter/scorer systems, and/or methods described herein, can facilitate the production of edged single face and corrugated using relatively wide medium and liner inputs. This improves efficiency not only because multiple product streams of edged single face and corrugated can be produced, but also because the corrugator does not have to be shut down to reconfigure the machinery to run narrow widths of liner and medium corresponding to the size of the particular product being produced. Rather, the examples described herein can enable the corrugator to change from, for example, producing a typical single face or double-faced corrugated product to producing an edged single face or edged corrugated product without stopping. The adhesive application and removal of the adhesive-free second zones from the web can also occur at line speed, further improving efficiency.

### Example 2: Additional Examples of Shipping Mailers Made of Single Face Corrugated Material

As noted above, the single face web can comprise any selected number of first zones or stripes comprising adhesive and any selected number of second zones or stripes that are adhesive-free. In some examples, adhesive can be selectively applied to the corrugated medium as described above to create first zones comprising adhesive and second zones that are adhesive-free, and the second zones can be left intact. Stated differently, the second zones are not cut and removed from the single face web, but instead remain as areas where the fluted medium is not adhered to the liner. In certain examples, the adhesive-free second zones can be bounded on each longitudinal edge by first zones comprising adhesive. In certain examples, a shipping mailer can comprise at least one adhesive-free second zone (e.g., spaced inwardly from the edges of the mailer) and at least two first zones comprising adhesive. The adhesive-free second zone can be located between the two first zones. Leaving the fluted medium intact and not adhered to the liner in at least one adhesive-free second zone can allow a shipping mailer to more easily conform to an item received in the shipping mailer, as further described below.

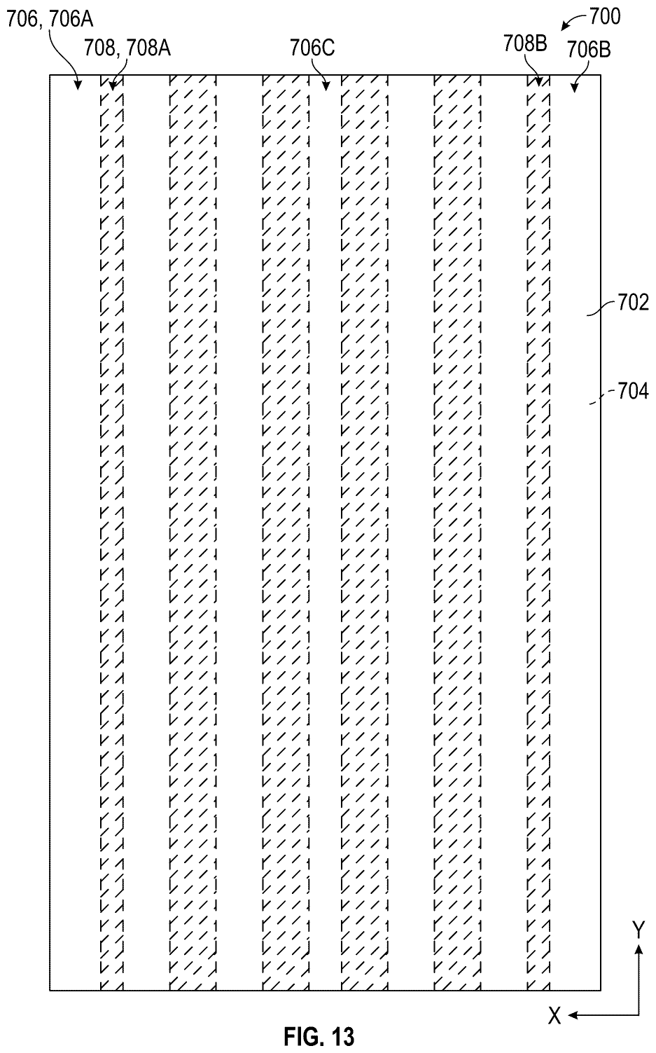

FIG. 13 schematically illustrates a blank 700 for a shipping mailer comprising a one-piece body made of single face corrugated material before the formation of fold lines in the blank. The blank 700 can comprise a fluted medium layer 702 and a liner layer 704 beneath the fluted medium layer. The flutes of the fluted medium layer 702 are not shown for clarity, but extend edge to edge across the full width of the blank 700 parallel or substantially parallel to the x-axis. In the illustrated example, the fluted medium layer 702 can be coextensive with the liner layer 704 such that the fluted medium completely covers the liner (stated differently, the blank 700 is not edged single face and the liner layer and the fluted medium layer have the same dimensions). The fluted medium layer 702 can comprise a plurality of first zones 706 comprising adhesive and a plurality of second zones 708 that are adhesive-free. In particular, the illustrated example includes seven first zones 706 including a first zone 706A extending along the left edge of the blank and a first zone 706B extending along the right edge of the blank. The first zones can have different width dimensions (e.g., measured along the x-axis in FIG. 13). For example, a first zone 706C extending along the centerline of the blank 700 can be narrower than the other first zones 706.

The first and second zones 706, 708 can alternate inwardly of the edges of the blank. In the illustrated example the blank 700 comprises six second zones 708, including a left-most second zone 708A and a right-most second zone 708B. Each of the adhesive-free second zones 708 can be bordered on both longitudinal edges by a first zone 706 comprising adhesive. The second zones 708 can also have different widths. For example, the outermost second zones 708A and 708B can be narrower than the other second zones located between them. In the second zones 708, the fluted medium layer 702 is not adhered to the liner layer 704 leaving them relatively free to move and/or flex independently. The first zones 706 and the second zones 708 can be created using any of the single facer systems described herein, such as those described above with reference to FIGS. 1A-7.

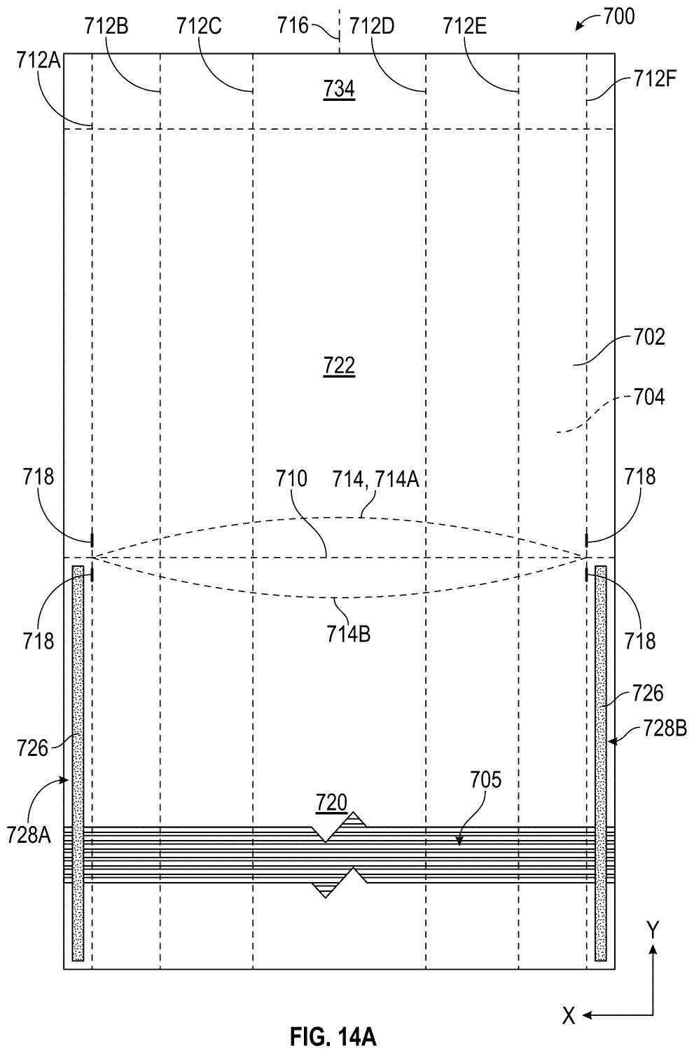

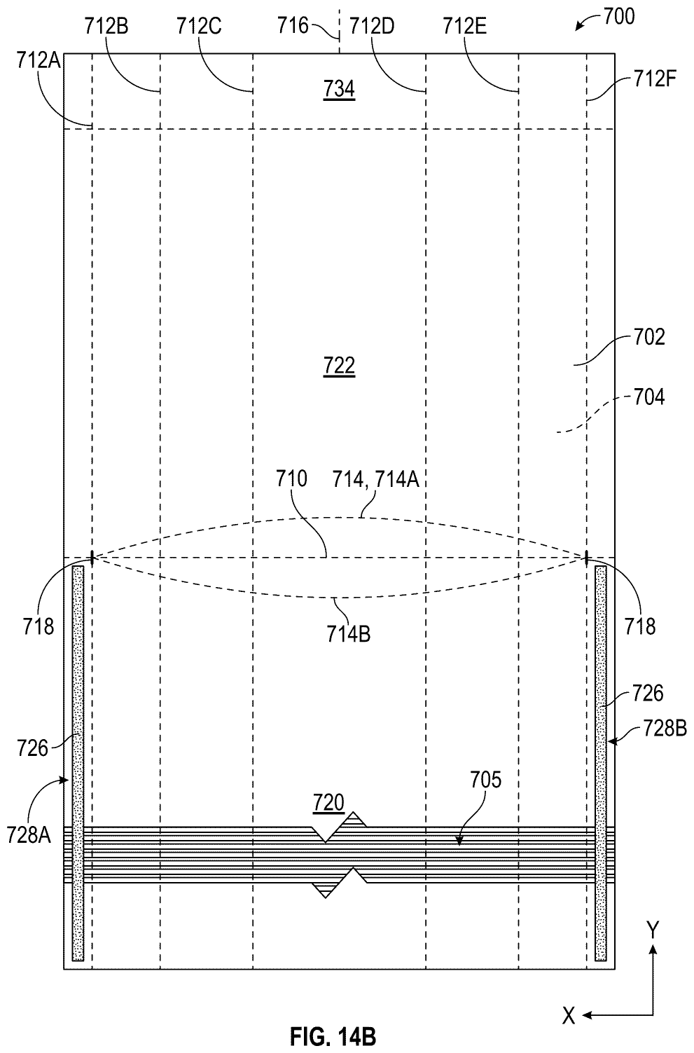

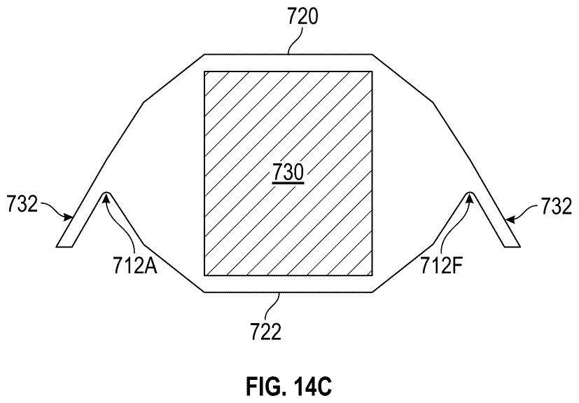

FIG. 14A illustrates the blank 700 after formation of fold lines in the fluted medium layer 702. A small section of the flutes of the fluted medium layer 704 is shown at 705. The blank 700 can comprise a center fold line 710 extending across the width of the blank parallel to the flutes. The blank can also comprise a plurality of longitudinal fold lines 712 (also referred to as “longitudinally extending fold lines”). The longitudinal fold lines 712 can be perpendicular or substantially perpendicular to the flutes (e.g., parallel to the y-axis in FIG. 14A). The longitudinal fold lines 712 can also be spaced inwardly from the longitudinal edges of the blank. In the illustrated example, the longitudinal fold lines 712 can be located in first zones 706 of the fluted medium layer 702. For example, the illustrated blank includes six longitudinal fold lines 712A-712F, and all of the first zones 706 except the centermost first zone 706C include a longitudinal fold line 712.

The blank 700 also includes curved fold lines 714 extending from and returning to the center fold line 710. A first curved fold line 714A extends on one side of the center fold line 710 and a second curved fold line 714B extends on the opposite side of the center fold line 710. The curved fold lines 714A and 714B each define a crest or apex on the longitudinal axis 716 of the blank. When the blank is folded about the center fold line 710 to form the walls of the shipping mailer, the curved fold lines 714A and 714B can be brought together and aligned. This can allow the resulting end wall of the shipping mailer to fold, expand, and/or conform to an object inserted into the shipping mailer. The curved fold lines 714A and 714B are spaced inwardly from the side edges of the blank so as not to compromise the seal between the walls along the edges of the shipping mailer. In some examples, the curved fold lines 714A and 714B can be spaced inwardly of the first zones 706A and 706B (e.g., the curved fold lines 714A and 714B can originate at the inner edges of the first zones 706A and 706B).

The blank 700 can also comprise a plurality of knife cuts 718 (also referred to as “perforations”). The knife cuts 718 can be arranged in pairs on opposite sides of the center fold line 710 and can extend through the liner layer and through the fluted medium layer. FIG. 14A illustrates a first pair of knife cuts 718 on the right side of the blank 700 in the first zone 706B and a second pair of knife cuts 718 on the left side of the blank in the first zone 706A. The knife cuts 718 of each pair of knife cuts can be aligned with a longitudinal fold line 712, such as the outermost fold lines 712 closest to the edges of the blank. Each knife cut 718 can be spaced a short distance from the center fold line 710 along the y-axis. When the blank is folded about the center fold line 710, the knife cuts 718 of each pair can overlap. This can form an area of weakness in the end wall of the shipping mailer. By gripping the end edge of the shipping mailer proximate the knife cuts 718 and pulling along the associated longitudinal fold line 712, the knife cuts 718 can initiate a tear in both walls of the shipping mailer to facilitate opening the shipping mailer. The example illustrated in FIG. 14A includes two pairs of knife cuts 718, but in other examples the blank can include a single pair of knife cuts or more than two pairs of knife cuts as shown in FIG. 14B. In yet other examples, the knife cuts 718 can extend across the center fold line 710 from the first wall to the second wall.

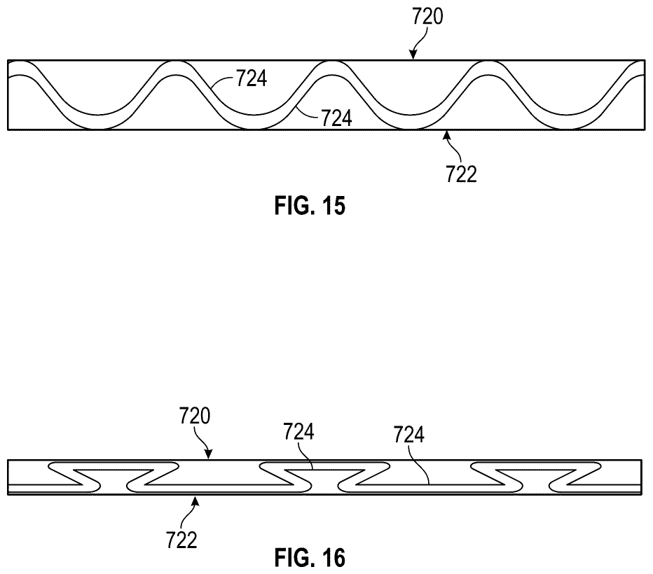

As noted above, the fluted medium layer 702 can extend across the entire width of the blank 700. When the blank 700 is folded in half about the center fold line 710 to form a shipping mailer, the portion below the center fold line 710 can form a first wall 720 of the shipping mailer and the portion above the center fold line 710 can form a second wall 722. When the first and second walls 720 and 722 are folded together, the flutes 724 of the two walls can nest as shown in FIG. 15, at least when the shipping mailer is in an unstuffed state. Adhesive can be applied to the longitudinal edge portions of one or both walls, and the flutes in the longitudinal edge portions can be crushed such that they become interlocked to bond the side walls together and seal the side edge portions of the shipping mailer.

For example, referring again to FIG. 14A, adhesive 726 can be applied to the flutes along the side edge portions 728A and 728B of the first wall 720 (and/or along the side edge portions of the second wall 722). In certain examples, the longitudinal fold lines 712A and 712F can be adjacent the respective side edge portions 728A and 728B where adhesive 726 is applied. In certain examples, the side edge portion 728A can be bounded by the longitudinal fold line 712A, and the side edge portion 728B can be bounded by the longitudinal fold line 712F. Stated differently, the longitudinal fold lines 712A and 712F can be located inward of the respective side edge portions 728A and 728B. In certain examples, the side edge portions 728A and 728B can have the same width (x-axis dimension) as the first zones 706A and 706B, or can be larger or smaller. For example, in the illustrated example the side edge portions 728A and 728B have a smaller width than the first zones 706A and 706B.

As noted above, after adhesive is applied to the flutes in the side edge portions 728A and 728B the first wall 720 can be folded over onto the second wall 722 so that the flutes of the two walls nest together. The side edge portions of the first and second walls can be pressed together to crush the flutes and adhere the side edge portions of the first wall to the side edge portions of the second wall to form sealed side edge portions. FIG. 16 shows the nested flutes 724 of the two walls 720 and 722 in the side edge portions after they have been crushed. The crushed flutes 724 can form trapezoidal shapes that interlock the first wall 720 and the second wall 722 along the side edge portions of the mailer. The combination of the adhesive and the interlocking flutes can provide a strong seal along the side edge portions of the shipping mailer. In certain examples, the fold lines 712A and 712F can be the inner boundary lines of the crushed flutes in the side edge portions. In other examples, the fold lines 712A and 712F can be spaced inwardly of the boundary between the crushed flutes and the intact flutes.

When the first and second walls 720, 722 are folded together and the side edge portions are sealed, the blank can form a shipping mailer similar in appearance to the shipping mailer 500 shown in FIG. 10. The formed shipping mailer can have a closed first end portion comprising the center fold line 710 and the curved fold lines 714A and 714B. The shipping mailer can further comprise a second end portion defining an opening. The opening at the second end portion can be scalable by a closure, such as a closure flap 734 or flange at the upper end of the second wall 722 that can be folded over onto the first wall 720 to close the opening. In some examples, the closure flap 734 can comprise adhesive, foldable metal tabs, or other securing means to adhere or secure the closure flap to the first wall. In other examples, the first and second walls can be pressed together and attached such as by adhesive or hot melt and the application of heat and/or pressure (e.g., in a press) to close and seal the opening.

Shipping mailers in which the liner layer is adhered to the fluted layer in certain zones but not in other zones can provide certain advantages. For example, the liner layer and the fluted medium layer can move, flex, and/or bend independently in the zone(s) where the two layers are not adhered. Relatively strong attachment between the fluted layer and the liner layer can be maintained by using relatively smaller flute sizes, for example, B-flute (⅛ inch (3.2 mm) thickness), T-flute (0.085 inch (2.2 mm) thickness), E-flute ( 1/16 inch (1.6 mm) thickness), and/or F-flute ( 1/32 inch (0.8 mm) thickness). Where greater cushioning is desired, A-flute (¼ inch (6.35 mm) thickness) medium or C-flute ( 3/16 inch (4.8 mm) thickness) medium can be used. The above examples can also be made using edged single face with any flute size. However, in certain examples edged single face may be preferred with relatively larger flute sizes such as A-flute to allow a direct seal between the liner layers at the edges. The added flexibility provided by the adhesive-free second zones can also permit the use of a heavier/thicker liner layer paper than would otherwise be possible.

Additionally, the sealed side edge portions in which the flutes are crushed, interlocked, and adhered can also provide certain advantages. Referring to FIG. 14C, when a relatively large or thick object 730 is inserted into the shipping mailer, the sealed side edge portions 732 can fold along their inner edges, and/or along the boundary line between intact flutes and crushed flutes. In the example of FIG. 14C, the second wall 722 has folded about the fold lines 712A and 712F such that the scaled side edge portions 732 are angled downwardly in the figure. This is because the inner edge of the crushed areas of the flutes acts like a fold line or score line, causing the walls to fold about the edges of the crushed flute areas as described above. The folding of the walls along the inner edges of the sealed side edge portions 732 can relieve stress on the sealed side edge portions 732. The strength of the interlocking flutes between the first and second walls 720, 722 in the scaled side edge portions 732 can also reduce the likelihood that the sealed side edge portions will peel apart. Other lines of weakness along and/or adjacent the inner edges of the sealed side edge portions can also be used, such as cuts, lines or regions of reduced thickness, etc.

Although the example shown in FIGS. 14A-14C includes four longitudinal fold lines 712B-712E between the sealed side edge portions 732, in other examples the shipping mailer can include one, two, or three longitudinal fold lines, no longitudinal fold lines, or more than four longitudinal fold lines between the scaled side edge portions 732. Additionally, shipping mailer blanks configured as shown in FIGS. 14A-14C can have the fluted medium layer fully adhered to the liner layer, and need not include adhesive-free zones.

### Example 3: Shipping Mailer with Perforated Tear-Off Strip

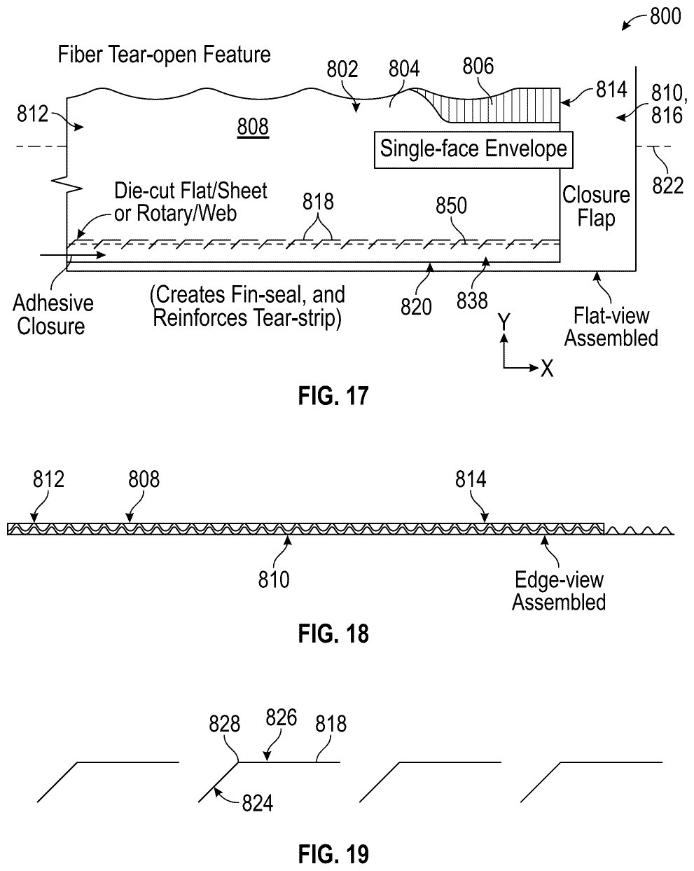

FIGS. 17-20 illustrate another example of a shipping mailer 800 configured similarly to the examples described above, and including a plastic-free tear-off strip formed in the main body of the shipping mailer. The shipping mailer 800 can be made from any of the materials described herein, such as containerboard, single face, etc. In the following example the shipping mailer 800 comprises edged single face, although the tear-off strip examples described herein can also be implemented on shipping mailers made of containerboard (e.g., lacking flutes) or other corrugated or non-corrugated fiber-based materials.

In the illustrated configuration, the shipping mailer 800 comprises edged single face corrugated material 802 comprising a liner layer 804 and a fluted medium layer 806 that is narrower than the liner 804 such that the liner 804 extends beyond the fluted layer 806 on both sides. The portions of the liner layer 804 that extend beyond the fluted medium layer are referred to herein as “finned edge portions” or “fins.” In certain examples, the single face material can be folded along a fold line (e.g., parallel to the flutes) to form a first wall 808 and a second wall 810 (FIG. 18). The first and second walls 808, 810 can be adhered together along their respective finned edge portions to form the main body of the shipping mailer. The assembled shipping mailer can have a closed first end portion 812 and an open second end portion 814. In certain examples, the second wall 810 can comprise a flap 816 or other closure that can close and seal the second end portion 814. In the case of a flap 816, the flap 816 can be folded over and secured and/or adhered to the first wall 808, as described elsewhere herein.

The shipping mailer can define an axis 822, referred to herein as a longitudinal axis (although it should be understood that the mailer can have any dimensions and the longitudinal axis 822 may not necessarily extend along the greatest dimension of the mailer). The longitudinal axis 822 can extend from the closed first end portion 812 to the second end portion 814 parallel to the x-axis in FIG. 17. In certain examples, the longitudinal axis 822 can extend in the direction of travel through the machinery that forms the mailer, parallel to the x-direction and generally perpendicular to the flutes.

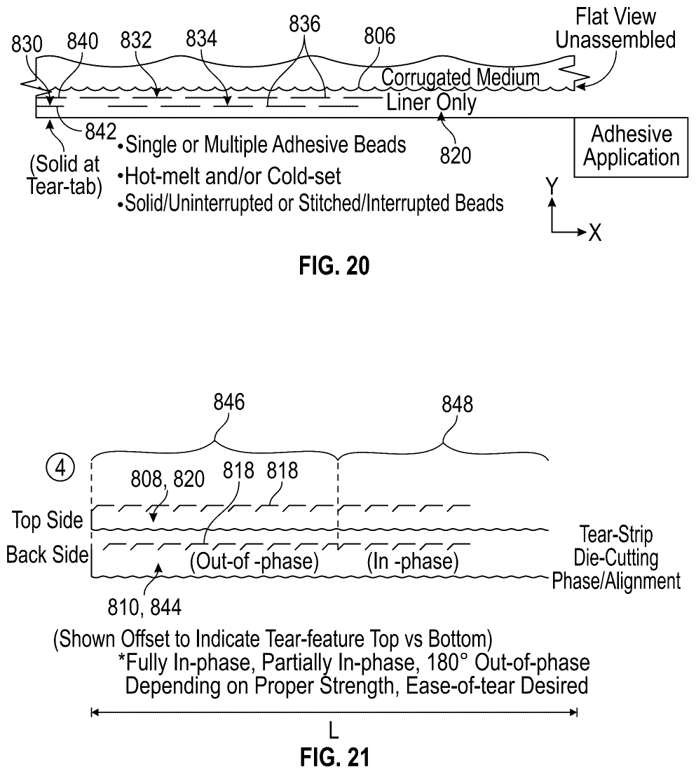

Referring to FIG. 17, the shipping mailer can comprise a plurality of perforations formed along one or both side edges of the mailer. FIG. 17 illustrates perforations 818 formed in the finned edge portion 820 of the first wall 808. Similar perforations can be formed in the finned edge portion of the second wall 810. Thus, when the walls 808 and 810 are folded together and adhered, the perforations of the first wall and the second wall can overlap (see, e.g., FIG. 20). The overlapping perforations of the first wall and the second wall can form a tear-off strip 838 along the edge of the shipping mailer. Stated differently, the perforations form a tear-off strip 838 in the adhered finned edge portions of the first wall and the second wall. By pulling the tear-off strip 838, the perforations 818 can break or rupture along both the first wall and the second wall, thereby creating an opening in the side of the shipping mailer.

Referring to FIG. 19, the perforations 818 can comprise first portions 824 and second portions 826. The first portions 824 can be oriented at an angle to the longitudinal axis 822 of the mailer (e.g., an angle of 30° to 60°, such as) 45°. The second portions 826 can be oriented parallel or substantially parallel to the longitudinal axis 822. The first and second portions of the perforations meet at apices 828. The first portions 824 are positioned closer to the side edge of the shipping mailer than the second portions 826. In the illustrated example the perforations 818 extend from the closed first end portion 812 to the second end portion 814, but in other examples they can extend along a portion of that distance. For example, the closed first end portion 812 can be free of perforations, for example, where greater strength is specified at the closed first end portion.

Referring to FIG. 20, in certain examples, the tear-off strip 838 can comprise a start tab or tear tab 830. In certain examples, a tear tab can be formed in one or both of the first wall 808 and/or the second wall 810. FIG. 20 shows a tear tab 830 formed by a pair of parallel, spaced apart knife cuts 840 and 842 through the finned edge portion 820 of the liner of the first wall 808. The tear tab(s) can be used to initiate tearing of the perforations 818 of the tear-off strip 838 when opening the shipping mailer.

The finned edge portions can be adhered together in a variety of ways. For example, the finned edge portions can comprise a single adhesive bead or multiple adhesive beads. The adhesive can comprise hot melt adhesive (e.g., a thermoplastic adhesive), cold-setting adhesive, plant-based adhesives such as corn starch, etc. FIG. 20 illustrates one example in which the finned edge portion 820 includes two parallel adhesive lines 832 and 834, each comprising a plurality of spaced apart adhesive beads 836. The adhesive beads 836 of the adhesive line 832 can be longitudinally offset from the adhesive beads 836 of the adhesive line 834 along the x-axis. In certain examples, the adhesive lines can be outward of the perforations 818, or at least a portion of the perforations 818. Dashed line 850 in FIG. 17 illustrates the approximate location of an adhesive line. The line 850 crosses the first portions 824 of the perforations 818, and is outward of the second portions 826 (e.g., offset toward the side edge of the shipping mailer). By positioning the adhesive outward of the second portions 826 of the perforations 818, an opening into the shipping mailer will be created when the tear-off strip 838 is removed.

In certain examples, the position of the perforations 818 of the first wall 808 and the position of the perforations 818 of the second wall 810 along the longitudinal axis 822 can be selected to vary the strength of the tear-off strip 838. For example, the perforations 818 of the first wall and the second wall can be aligned (e.g., directly overlaid and/or overlapped) along the longitudinal axis 822. This can reduce the force necessary to break the perforations. The perforations of the first wall and the second wall can also be offset longitudinally from each other by any amount. For example, the perforations 818 of the first wall 808 can be offset along the positive x-axis relative to the perforations 818 of the second wall 810 by 10% of the length of the perforations 818, 20% of the length of the perforations 818, 30% of the length of the perforations 818, 40% of the length of the perforations 818, 50% of the length of the perforations 818, 60% of the length of the perforations 818, 70% of the length of the perforations 818, 80% of the length of the perforations 818, 90% of the length of the perforations 818, 100% of the length of the perforations 818, etc. Where the perforations of the two walls are offset, the perforations can be said to be “out of phase.” Where the perforations of the two walls are aligned and directly overlapping, the perforations can be said to be “in phase.”

Referring to FIG. 21, the perforations of the first wall and the second wall can be in phase along a portion of the length L of the shipping mailer (e.g., measured along the longitudinal axis 822), and out of phase along a portion of the length of the shipping mailer. FIG. 21 illustrates a representative example in which the finned edge portion 820 of the first wall 808 is shown side by side with the finned edge portion 844 of the second wall 810 for purposes of illustration. The perforations 818 of the first wall 808 and the second wall 810 can be formed in two zones along the longitudinal axis 822. In the first zone 846, the perforations 818 of the second wall 810 are longitudinally offset from the perforations 818 of the first wall 808 (e.g., the perforations are out of phase). This has the effect of increasing the force required to initiate tearing of the perforations and propagation of the tear along the tear-off strip 838 in the first zone 846. In the second zone 848, the perforations 818 of the first and second walls are aligned along the longitudinal axis 822, and thus directly overlap in the assembled shipping mailer. This reduces the force required to initiate and propagate tearing of the perforations, making the tear-off strip 838 easier to separate in the second zone 848.

The first and second zones 846, 848 can extend along any proportion of the length L of the shipping mailer. For example, the first zone 846 can be 10% to 60% of the length L of the shipping mailer, such as 20% to 50%, 20% to 40%, 20% to 30%, etc.

In certain examples, the perforations 818 of the first wall 808 can have the same size and shape as the perforations of the second wall 810. In other examples, the perforations of one wall can have a different size and/or shape than the perforations of the other wall. For example, the perforations of one wall can be longer than the perforations of the other wall in a particular zone (e.g., the first zone), which can increase the force required to tear the perforations similar to longitudinally offsetting the perforations. In other examples, the perforations can be different sizes and can also be longitudinally offset.

The perforations of the tear-off strip can be formed in-line during production of shipping mailer blanks, such as by die-cutting, rotary cutting, etc. In certain examples, a perforated tear-off strip can be formed along both sides of the shipping mailer.

The tear-off strip examples described above can provide a number of significant advantages. For example, the perforated tear-off strips provide a way of opening the shipping mailer that does not require any single-use plastic materials as in conventional embedded tape or strip “tear tape” openers. This can facilitate the production of a shipping mailer that is entirely plastic-free, with the associated benefits of improved recyclability. Additionally, because the perforated tear-off strip is oriented along the longitudinal axis of the shipping mailer (e.g., perpendicular to the opening at the second end), the perforated tear-off strip can be formed in the direction of motion through the corrugator or mailer forming machinery. This can significantly improve throughput and reduce production time as compared to traditional plastic tear tape openers, which are typically oriented perpendicular to the direction of motion through the corrugator and require that the shipping mailer blank be slowed down or stopped entirely for placement. Further, by offsetting the perforations of one wall relative to the other, the strength of the perforated tear-off strip can be controlled at particular locations on the shipping mailer. For example, offsetting the perforations of one wall relative to the other wall at the closed first end portion can increase the strength of the tear-off strip in that zone, which can be beneficial for accommodating large and/or heavy objects which tend to place greater stress at the closed end of the mailer. The perforations can be aligned at the second end portion where reduced strength can be beneficial for initiating tearing of the perforated tear-off strip.

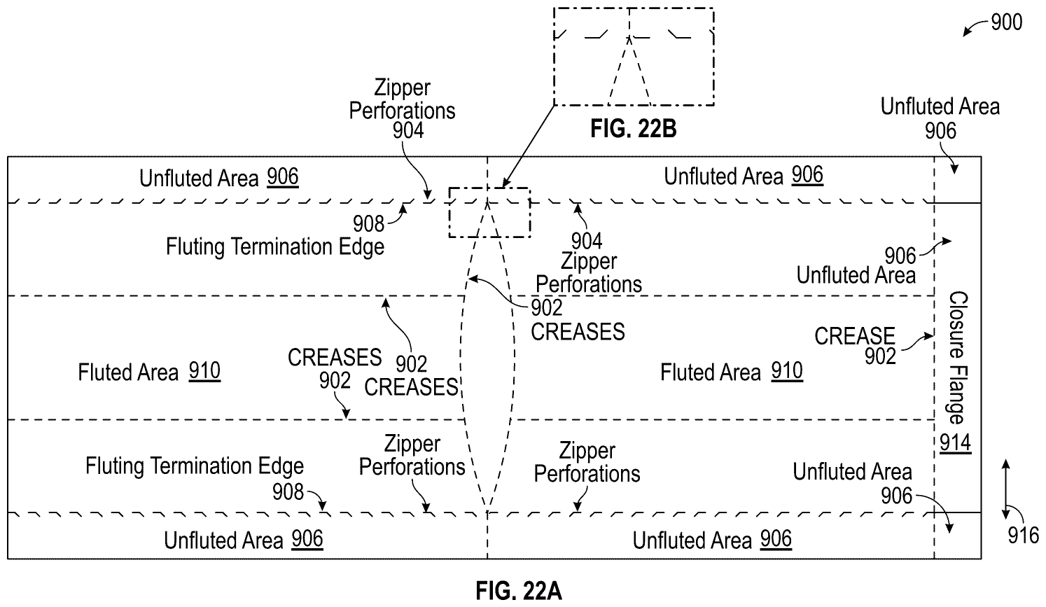

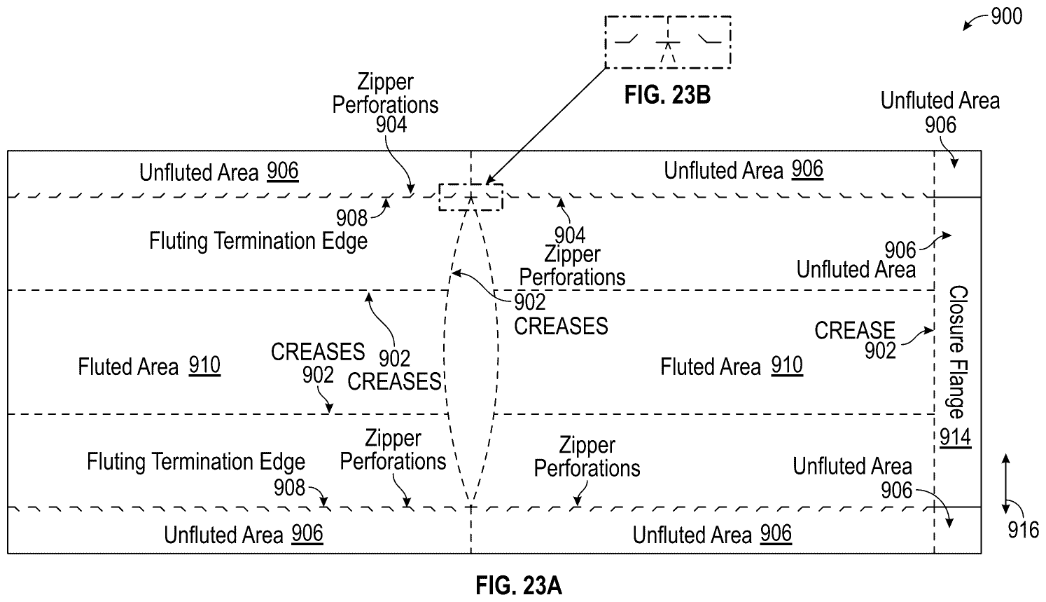

FIGS. 22A-25B illustrate particular implementations of the perforated tear-off strips described herein on a variety of shipping mailers. FIGS. 22A and 22B show a representative example of a shipping mailer 900 made of edged single face material and comprising curved creases 902 formed in the flutes of the closed first end portion, the shipping mailer further comprising a tear-off strip on both sides that are formed from perforations 904 that are out of phase. Unfluted areas of the blank are indicated at 906, and the terminal edge of the flutes at 908. Fluted areas are indicated at 910. A closure flange is indicated at 914. Double headed arrow 916 indicates the direction of the corrugations/flutes. FIGS. 23A and 23B show another example of the shipping mailer 900 made of edged single-face material and comprising curved creases 902 formed in the flutes of the closed first end portion, the shipping mailer further comprising a tear-off strip on both sides that are formed from perforations that are in phase (e.g., aligned along the longitudinal axis).

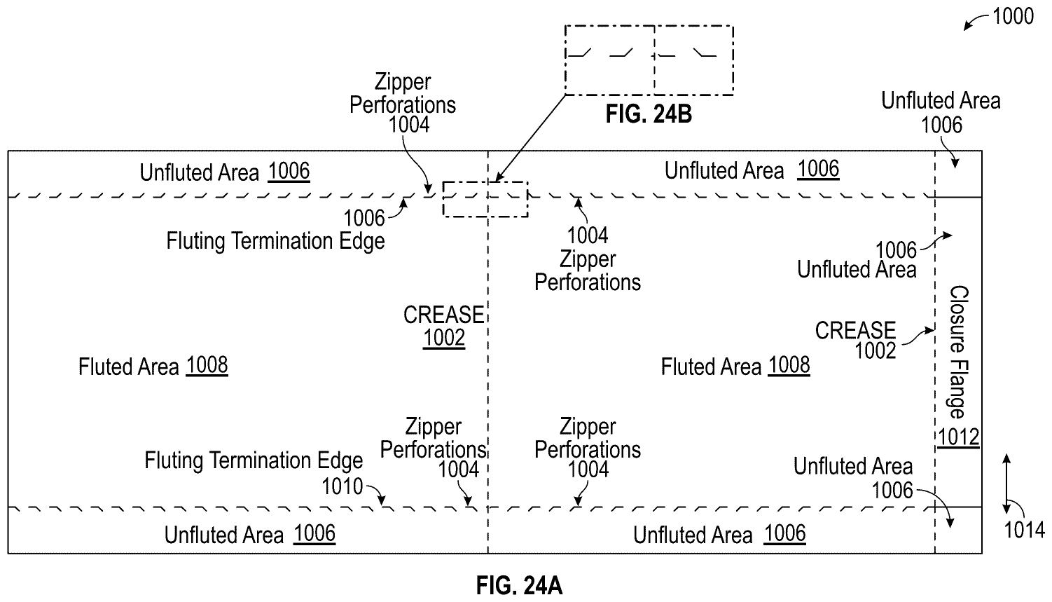

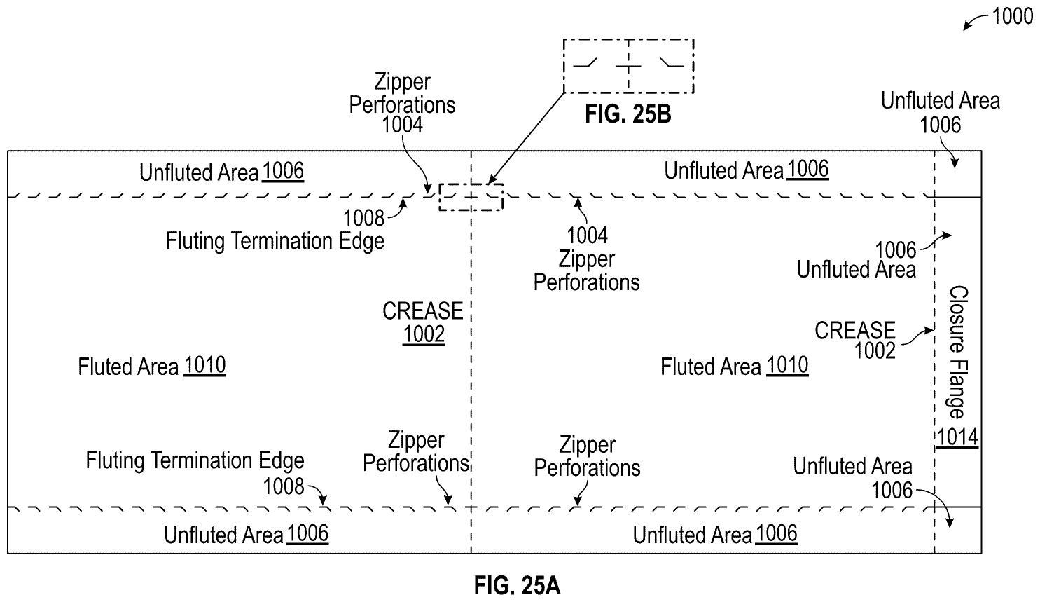

FIGS. 24A and 24B show a representative example of a shipping mailer 1000 made of edged single face material and comprising a straight crease 1002 formed at the closed first end portion, the shipping mailer further comprising tear-off strips on both sides formed from perforations 1004 that are out of phase. Unfluted areas are indicated at 1006. Fluted areas are indicated at 1008. The termination edges of the flutes are indicated at 1010. A closure flange is indicated at 1012, and the direction of the flutes is indicated by double-headed arrow 1014. FIGS. 25A and 25B show another representative example of the shipping mailer 1000 made of edged single-face material and comprising a straight crease 1002 formed at the closed first end portion, the shipping mailer further comprising tear-off strips on both sides formed from perforations 1004 that are in phase.

It should be understood that any of the perforated tear-off strip embodiments described herein can be combined with any of the shipping mailer embodiments and manufacturing methods described herein, including the shipping mailer 500, 700, and/or 1100.

The following description provides additional features, details, and advantages of the shipping mailer 800, a containerboard/single face mailer envelope with a dependable, integrated tear-open feature without and not-dependent on separable polymeric or filament components.

Unsolved Market Opportunities from Current Mailer Opening Constructions

Consumers have interest in direct-to-consumer ecommerce packaging that is comfortable, safe and easy to open without sharp instruments, without significant grip or pull strength required, that is dependable functioning (start, and fully opens without partial or entire failure), without any single-use plastic components, and can be responsibly disposed easily and quickly without separation of components/portions of now-opened package or requiring separate disposal (e.g., paper vs plastic components).

Package Purchaser/Fulfillment parties have interest in: optimal economics, dependable, high-functioning package without need for/use of single-use plastics, package materials/construction viewed by stakeholders as fully responsible, truly sustainable, ability to market as fully recyclable with corrugated in OCC stream.

Converter's interest in constructions that support profitable sales growth and market success include: converting effectiveness and operational efficiencies, minimum number of components, costs, minimum number of process/converting steps, optimal overall economics, ability to market package as fully/completely, compliant with industry standards-recyclable with corrugated, in OCC stream.

Containerboard producers interests include: ability to accept growing volume of fiber in the form of ecommerce mailers that will not contaminate the fiber stream and will not contaminate or impart failure or other operational cost increases, and retain integrity and reputation of recycled content containerboard and corrugated packaging (no micro-plastics generated from converted products or within subsequent production of recycled content containerboard.

Challenges with currently available tear-open features include the following. The majority of tear-open features for all but the lightest/weakest mailer envelopes tend to rely on pressure-sensitive linear-applicable polymeric-filament, and/or tough plastic film/tape components to provide reasonable case and dependable function in opening. The stronger the stock used (as in tougher Kraft Paper, Containerboard or Singleface) in the mailer, the greater the need for a strong and dependable tear-strip, and the greater the prevalence of non-fiber-based (single-use plastic, et al) opening features and components. These typically require an additional component to be purchased and applied in an additional process step. Uptime, throughput and economic challenges result. These strips, when not responsibly disposed of at end-of-life, can be a problematic source of litter. Being non-biodegradable they can and do result in input of persistent contaminants to the environment (macro and micro plastics). When responsibly disposed at end-of-life by the consumer, they require active separation from the now empty package, and active disposal in a separate waste stream (landfill as opposed to fiber/paper recapture and recycling).

When these strips travel with the package at time of recapture (as they do when not fully detached, or when fully detached and then intentionally tucked-into the empty mailer prior to placing into the OCC recapture stream), they are difficult and expensive to separate and remove. This causes significant operational challenges (contaminants in the process, resulting in poor quality stock, as well as jams in recycling and potential breaks in the papermaking process).

When considerable and growing quantities of these polymeric/filament opening strips are encountered, despite efforts to prevent-micro-plastics are created and subsequently become embedded in the otherwise clean, fiber, recycled paper/containerboard. The number, volume and weight of these are expected to increase over time, adulterating and reducing the desirousness/value of recycled paper and containerboard.

Fiber-based tear-strip approaches although not presenting the challenges and compromises above, can and typically are difficult to initiate and very likely to fail-causing consumer frustration and dissatisfaction with the product producer/marketer and the fulfilling retailer/retailer.

Conventional die-cutting of common tear-strip patterns of unreinforced, single thickness (body of fiber-based mailer/envelope) tend to open or otherwise fail in distribution if die-cut sufficiently to provide easy tear/low-pull-force. If they are designed and implemented to provide sufficient containment that tend to either be too difficult to pull or the force required exceeds the tensile strength of the fiber “strip” and failure ensues.

### Shipping Mailer and Tear-Off Strip Examples as Illustrated in Accompanying Drawings/Diagrams

A tear-open function and construction for containerboard and single face mailers is described herein with the following features: containerboard/single face constructed mailers, providing containment and product protection (market requirements); combined and converted such that the loading direction of the mailer is in the through-direction of papermaking, single face combining and envelope converting directions; the consumer-opening/tear-open feature also functions in the through (X-direction) rather than the cross-machine (Y-direction) that is typically, frequently employed in mailers and similar envelope type packages. The opening direction is in the same direction as loading direction, albeit specifically not in/on/across the original loading aperture (mouth of not-yet-closed envelope/mailer)

The tear-open feature (tear-off strip) can be constructed by: die-cutting using modified “tear-strip” knife/cutting-rule to create a pull-tab type initiator at one, or both ends of envelope, and in the direction of manufacture and envelope filling. Tear strip knife cuts may be aligned and “in-phase” (directly superimposed after envelope is finished), or may be completely out-of-phase/180 degrees out of phase, or partially in/out-of-phase as desired to accommodate differing/desired containerboard strengths and weights.

In certain examples, lesser strength constructions may benefit from fully or partially out-of-phase knife cuts to provide sufficient assurance of containment (as case of opening is already and more easily assured by nature of the lighter, lesser-strength containerboard). Higher-strength/heavier weight construction may benefit from fully or primarily in-phase (directly over-lapping once fully closed/converted) knife cuts on opposing faces of the envelope to provide case of opening (as confidence in containment, and prevention of unintended opening in distribution is already and more easily assured by material attributes.

The full or nearly full-adhesion employed in converting/for envelope closure (“fin seal”), and on opposing sides of the containerboard mailer envelope provide for the tensile strength suitable for assured, dependable performance (i.e., without break-off). For converting/closing the envelope and construction of the tear-strip element-cold-set and/or hot-set adhesives may be used-either singly or in combination. Hot melt for converting dependability and cold-set for economic advantages. Additionally, multiple, parallel narrow beads (perhaps versus a single, greater diameter bead) may be advantageous in certain examples, balancing performance and economics. Stitching or interrupted patterns (if multiple-in, or out-of-phase) may provide sufficient containment and tensile strength/tear-strip performance dependent on material weight/strength/containment specified by mailer size and product weight/volume.

Various versions can be provided to satisfy varying market interest—through die-cutting changes to either allow the tear-strip to be fully separated and removed on opening of mailer—or intentionally remaining connected to open mailer (while still providing complete and easy access, product removal in both versions) for the convenience of the consumer and to potentially case disposal (recycling).

### Utility, Advantages, Addressing Long-Felt Needs in the Industry

The tear-off strip examples herein utilize no polymeric tape or filament component or application for strong/heavy containerboard. They also employ only the underlying containerboard/single face sheet in combination with strategic die-cutting and strategic application of envelope-closing adhesive.

The examples described herein provide an easy, dependable means of consumer opening, without use of: tools (scissors, knives, etc.); separately sourced, purchased, applied materials; separate, separable filament or single-use plastic tape reinforcements

The disclosed examples utilize no polymeric tape or filament component or application for strong/heavy containerboard.

The disclosed examples employ only the underlying containerboard/single face sheet in combination with strategic die-cutting and strategic application of envelope-closing adhesive for construction.

The disclosed examples leverage the superior tensile strength of the containerboard in the X/through-direction of the paper, single face web and finished package.

The disclosed examples leverage the underlying fiber-alignment/directionality and innate “preference” of containerboard to encourage consistent, linear tear on opening, thus supporting functionality and dependability.

The disclosed examples obviate the challenges operational effectiveness, uptime, throughput, efficiencies and economics in current products.

The disclosed examples obviate environmental and other contaminant-driven concerns in supply chain.

The disclosed examples provide a fully recyclable and sustainable solution.

The disclosed examples reduce costs, provide significant value to market, supply-chain (increased uptake, sales opportunities).

The disclosed examples are believed to be the first successful (strength/performance) fiber-only tear-open feature for higher strength, heavier weight web-stock like containerboard and single face.

The disclosed examples utilize no polymeric tape or filament component or application for strong/heavy containerboard (which typically is required for containment and product protection in this approach to distribution).

The disclosed examples employ and leverage the underlying containerboard/single face sheet in combination with strategic die-cutting and strategic application of envelope-closing adhesive to create tear-open feature and provide the performance advantages.

The disclosed examples provide the advantage that the design/alignment of the tear-off feature, its construction and manufacturing are 90 degrees away from conventional mailers.

The disclosed examples leverage the underlying attributes of containerboard (higher-tensile and lower tear-resistance in machine direction) by means of aligning tear-open feature in the X direction, rather than the Y-direction typically employed for tear-open features in heavier mailers.

The disclosed examples represent a departure in opening direction (in X, vs Y direction on web/finished product).

The disclosed examples include a radically different, strategic combination of material type, die-cutting and envelope adhesive type/application patterns to provide the unique combination of dependable containment in distribution along with ease, function and dependability of the opening feature.

### Example 4: Shipping Mailer with Curved Fold Lines and Perforated Tear-Off Strip

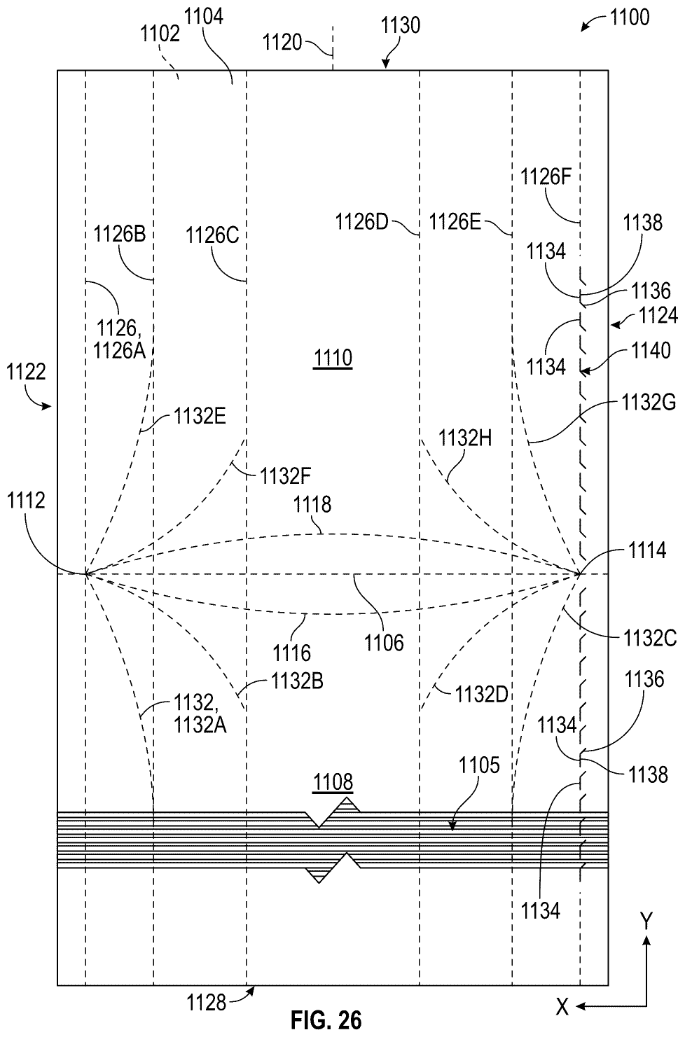

FIG. 26 illustrates another example of a blank 1100 for a shipping mailer made from a one-piece body comprising single face corrugated material. The blank 1100 can include a plurality of straight longitudinal fold lines, curved central fold lines, curved fold lines extending between the longitudinal fold lines and the center fold line, and a tear-off strip on one side. The blank 1100 can comprise a liner layer 1102 and a fluted medium layer 1104 that is coextensive with the liner layer 1102 as described above with reference to the blank 700. In certain examples the flutes of the fluted medium layer 1104 can extend horizontally parallel or substantially parallel to the x-axis. A small section of the flutes of the fluted medium layer 1104 is shown at 1105. In some examples the fluted medium layer 1104 can comprise a plurality of first zones comprising adhesive where the liner layer 1102 and the fluted medium layer 1104 are adhered together, and one or a plurality of second zones that are adhesive-free similar to the blank 700 described above. In some examples, the fluted medium layer and the liner layer can be adhered across their entire overlapping area, and need not include adhesive-free zones.

The blank 1100 can comprise a center fold line 1106 extending across the blank in the direction of the x-axis. The center fold line 1106 can divide the blank 1100 into a first portion that forms a first wall 1108 and a second portion that forms a second wall 1110 when the portions are folded together about the center fold line 1106. Two nodes 1112 and 1114 can be located on the center fold line 1106 and spaced inwardly from the longitudinal edges 1122 and 1124 of the blank. A curved fold line 1116 can extend between the nodes 1112 and 1114 across the first wall 1108. A curved fold line 1118 can extend between the nodes 1112 and 1114 across the second wall 1110. Apices of the curved fold lines 1116 and 1118 can be located along a central longitudinal axis 1120 of the blank on opposite sides of the center fold line 1106.

A plurality of straight longitudinal fold lines 1126 can extend from the lower edge 1128 of the first wall 1108 (which becomes the upper edge of the first wall after the walls are folded together) to the upper edge 1130 of the second wall. In a direction from left to right in FIG. 26 along the x-axis, the blank 1100 can comprise six longitudinal fold lines 1126A, 1126B, 1126C, 1126D, 1126E, and 1126F. The left-most longitudinal fold line 1126A can extend through the node 1112, and the right-most longitudinal fold line 1126F can extend through the node 1114. In some examples, the longitudinal fold lines 1126 can extend through first zones in which the fluted medium layer is adhered to the liner layer.

The blank 1100 can further comprise a plurality of fold lines 1132 extending from the node 1112 or the node 1114 to a longitudinal fold line 1126 on the same side of the central longitudinal axis 1120 as the node from which the fold lines 1132 originate. For example, the first wall 1108 can comprise a fold line 1132A extending from the node 1112 to the longitudinal fold line 1126B and a fold line 1132B extending from the node 1112 to the longitudinal fold line 1126C. In the illustrated example the fold lines 1132A and 1132B are curved with a concavity that is oriented downward toward the edge 1128 of the first wall 1108 and outwardly toward the longitudinal edge 1122. The first wall 1108 can further comprise a fold line 1132C extending from the second node 1114 to the longitudinal fold line 1126E and a fold line 1132D extending from the second node 1114 to the longitudinal fold line 1126D. The fold lines 1132C and 1132D can be curved with a concavity that is oriented downwardly toward the edge 1128 of the first wall and outwardly toward the longitudinal edge 1124. The second wall 1110 can comprise similar fold lines mirrored across the center fold line 1106, including fold lines 1132E and 1132F originating from the first node 1112. The second wall can further comprise fold lines 1132G and 1132H originating from the second node 1114. When the first and second walls 1108, 1110 are folded together, the fold lines 1132 of the first wall 1108 can overlap the corresponding fold lines 1132 of the second wall 1110. For example, the fold line 1132A can overlap the fold line 1132E when the first and second walls are folded together. The fold lines 1132 of the first wall 1108 and of the second wall 1110 can also curve inwardly and upwardly toward the opening (e.g., toward the second end portion) when the first and second walls are folded together, with a concavity oriented toward the nearest longitudinal/side edge of the shipping mailer (e.g., toward the nearest sealed side edge portion). In other examples, the fold lines 1132 can be straight, or some fold lines 1132 can be straight and some fold lines 1132 can be curved. The fold lines 1132 can also extend part way between the center fold line 1106 and a respective longitudinal fold line 1126, and need not extend the full distance between the center fold line and the longitudinal fold line. The fold lines 1132 also need not start at the center fold line 1106, and can start at a location spaced away from the center fold line.

The blank 1100 can further comprise a plastic-free tear-off strip 1140 formed in the main body of the blank similar to the examples described above with reference to FIGS. 17-25B. For example, the blank 1100 can comprise a plurality of perforations 1134 formed along the right-hand side edge portion of the blank, although the perforations can be formed in either or both side edge portions. Where the blank 1100 comprises co-extensive liner and fluted medium layers, the perforations can extend through both the liner layer and the fluted medium layer. In examples where the blank 1100 comprises edged single face, the perforations can be formed in the opposing liner layers as described above with reference to the shipping mailer 800.

The perforations 1134 can comprise first portions 1136 that extend at an angle to the longitudinal axis 1120 and second portions 1138 that are parallel or substantially parallel to the axis 1120. In the illustrated example, the second portions 1138 are aligned with the longitudinal fold line 1126F and the first portions 1136 extend toward the longitudinal edge 1124 of the blank (the nearest longitudinal edge to the perforated tear-off strip). On the first wall 1108, the perforations 1134 are oriented such that the first portions 1136 extend upwardly toward the central fold line 1106 at an angle of 15° to 60° with the x-axis, such as 30° to 60° or 45° with the x-axis. On the second wall 1110, the perforations 1134 are oriented such that the first portions 1136 extend downwardly toward the central fold line 1106 at an angle of 15° to 60° with the x-axis, such as 30° to 60° or 45° with the x-axis.

When the walls 1108 and 1110 are folded together and adhered, the perforations 1134 of the first wall and the second wall can overlap to form the tear-off strip 1140 along the edge of the shipping mailer. By pulling the tear-off strip 1140 (e.g., beginning at the closed end of the shipping mailer), the perforations 1134 can break or rupture along both the first wall 1108 and the second wall 1110 to create an opening in the side of the shipping mailer as described above.

As described above, the position of the perforations 1134 of the first wall 1108 and the position of the perforations 1134 of the second wall 1110 along the longitudinal axis 1120 can be selected to vary the strength of the tear-off strip 1140. For example, the perforations 1134 of the first wall and the second wall can be aligned, also referred to as “in phase,” (e.g., directly overlaid and/or overlapped) along the longitudinal axis 1120 after formation of the shipping mailer, which can reduce the force necessary to break the perforations. The perforations of the first wall and the second wall can also be offset longitudinally from each other by any amount, also referred to as “out of phase.” For example, the perforations 1134 of the first wall 1108 can be offset along the positive y-axis relative to the perforations 1134 of the second wall 1110 by 10% of the length of the perforations, 20% of the length of the perforations, 30% of the length of the perforations, 40% of the length of the perforations, 50% of the length of the perforations, 60% of the length of the perforations, 70% of the length of the perforations, 80% of the length of the perforations, 90% of the length of the perforations, 100% of the length of the perforations, etc. The less the perforations of the first and second walls overlap, the greater the resistance to tearing. Thus, in some examples the perforations 1134 can overlap in a first region that extends from the centerline at the closed first end portion to a predetermined location along the y-axis, and can be offset or partially overlapping in a second zone that is closer to the second end portion of the shipping mailer than the first region as described above with reference to FIG. 21. This arrangement can facilitate initiating rupture of the overlapping perforations in the first zone when opening the shipping mailer.

In certain examples, the tear-off strip 1140 can comprise a start tab or tear tab, such as a pair of parallel, spaced apart knife cuts as described above with reference to the shipping mailer 800 and the shipping mailer 700.

In certain examples, adhesive can be applied to the side edge portions of one or both of the walls 1108 and 1110, and the side edge portions can be folded together and crushed to form sealed side edge portions similar to the shipping mailer 700. In certain examples, the perforations 1134 can be located inwardly of the sealed side edge portions (e.g., offset from the adhesive bead toward the axis 1120) of the shipping mailer. In certain examples, the straight second portions 1138 of the perforations 1134 can be inward of the scaled side edge portions, and portions of the angled first portions 1136 can extend into the sealed side edge portions (e.g., into the region comprising the adhesive). In certain examples, both the straight second portions 1138 of the perforations 1134 and the angled first portions 1136 can be inward of the sealed side edge portions.

It should be understood that any of the features of any of the shipping mailer examples described herein can be combined in various combinations. For example, any of the shipping mailers 500, 700, and 900-1100 can be made from edged single face corrugated material, or from single face corrugated material where the liner and the fluted medium have the same dimensions (e.g., are coextensive). Any of the shipping mailers described herein, including the shipping mailer 500, the shipping mailer 700, and the shipping mailers 900-1100 can include any of the perforated tear-off strip examples described herein, and the perforations on the walls of the mailers can be in phase and/or out of phase. Any of the shipping mailers 500, 700, and 900-1100 can include first zones where the liner layer and fluted medium layer are not adhered and second zones where the liner layer and the fluted medium layer are adhered as described above. In any of the shipping mailers 500, 700, and 900-1100, the fluted medium layer and the liner layer can be adhered across their entire overlapping area, and need not include adhesive-free zones. Any of the shipping mailers 500, 700, and 900-1100 can include scaled side edge portions in which the flutes of the fluted medium layer are crushed and adhered together as described above. Any of the shipping mailers 500, 700, and 900-1100 can include curved fold lines extending between the center fold line and one or more longitudinal fold lines on the same side of the longitudinal axis as the curved fold line similar to the shipping mailer 1100. Any of the perforated tear-off strip examples described herein can be implemented on shipping mailers comprising single face corrugated material, and such shipping mailers need not have the fold line configurations of the examples above. Any of the shipping mailers 500, 700, and 900-1100 can also include longitudinal fold lines inward and/or along the edge of the sealed side edge portions. Where the flutes are crushed in the sealed side edge portions, the boundary line between intact and crushed flutes can induce the walls of the shipping mailer to bend in a manner similar to fold lines formed by scoring the flutes. Additionally, the single facer and corrugator machinery described herein can be configured to produce any of the shipping mailers described herein, including any of the shipping mailers 500, 700, and 900-1100.

### Additional Examples of the Disclosed Technology

In view of the above described implementations of the disclosed subject matter, this application discloses the additional examples enumerated below. It should be noted that one feature of an example in isolation or more than one feature of the example taken in combination and, optionally, in combination with one or more features of one or more further examples are further examples also falling within the disclosure of this application.

Example 1. A method, comprising: in a single facer system, drawing medium from a roll of medium into a pair of corrugating rollers; with the corrugating rollers, forming flutes in the medium to produce fluted medium; applying adhesive to flute tips of the fluted medium in selected zones such that in a downstream direction from the corrugating rollers, the fluted medium comprises a plurality of first zones comprising adhesive and a second zone that is adhesive-free, wherein the second zone is offset inwardly from outer edges of the fluted medium; and applying liner to the fluted medium to produce single face web.

Example 2. The method of any example herein, particularly Example 1, wherein applying adhesive to flute tips of the fluted medium further comprises applying adhesive to flute tips of the fluted medium in selected zones such that in a downstream direction from the corrugating rollers, the fluted medium comprises a plurality of first zones comprising adhesive and a plurality of adhesive-free second zones, and wherein each of the adhesive-free second zones is offset inwardly from outer edges of the fluted medium.

Example 3. The method of any example herein, particularly Example 2, wherein each adhesive-free second zone of the fluted medium is bounded on both sides by a first zone comprising adhesive.

Example 4. The method of any example herein, particularly any one of Examples 1-3, wherein adhesive is applied to flute tips of the fluted medium with an applicator roller, and applying adhesive to flute tips of the fluted medium further comprises removing adhesive from the applicator roller in a selected zone.

Example 5. The method of any example herein, particularly any one of Examples 1-4, wherein adhesive is applied to flute tips of the fluted medium with an applicator roller, and the applicator roller comprises a groove in its surface that forms the adhesive-free second zone on the fluted medium.

Example 6. The method of any example herein, particularly one of Examples 1-5, wherein adhesive is applied to flute tips of the fluted medium with an applicator roller, and applying adhesive to flute tips of the fluted medium further comprises applying adhesive from a plurality of adhesive baths to a plurality of zones on a surface of the applicator roller.

Example 7. The method of any example herein, particularly any one of Examples 1-6, wherein applying adhesive to flute tips of the fluted medium further comprises applying adhesive to flute tips of the fluted medium with a plurality of applicator rollers.

Example 8. The method of any example herein, particularly any one of Examples 1-7, further comprising removing the adhesive-free second zone of the fluted medium from the single face web.

Example 9. The method of any example herein, particularly Example 8, wherein removing the adhesive-free second zone of the fluted medium from the single face web further comprises cutting the fluted medium in the adhesive-free second zone with a blade assembly.

Example 10. The method of any example herein, particularly Example 8 or Example 9, further comprising cutting the single face web in a gap formed in the fluted medium by removal of the adhesive-free second zone to produce a plurality of edged single face product streams.

Example 11. The method of any example herein, particularly Example 10, further comprising producing a packaging product with edged single face of the edged single face product streams.

Example 12. The method of any example herein, particularly Example 1, wherein the liner is a first liner, and the method further comprises: applying a second liner to the single face web to produce a corrugated web; cutting the second liner and the fluted medium in the adhesive-free second zone of the fluted medium; and removing the cut second liner and adhesive-free second zone of the fluted medium from the corrugated web.

Example 13. The method of any example herein, particularly Example 12, further comprising cutting the corrugated web in a gap formed in the fluted medium by removal of the adhesive-free second zone to produce a plurality of edged corrugated material product streams.

Example 14. The method of any example herein, particularly Example 13, further comprising producing a packaging product with edged corrugated material of the edged corrugated material product streams.

Example 15. A single facer system, comprising: a pair of corrugating rollers positioned to receive medium from a roll of medium and form flutes in the medium to produce fluted medium; and an adhesive applicator system including an applicator roller positioned to apply adhesive to flute tips of the fluted medium, wherein the adhesive applicator system selectively applies adhesive or removes adhesive from selected zones on a surface of the applicator roller.

Example 16. The single facer system of any example herein, particularly Example 15, wherein the adhesive applicator system comprises an adhesive remover positionable to remove adhesive from a selected zone of the applicator roller surface as the applicator roller rotates.

Example 17. The single facer system of any example herein, particularly Example 16, wherein the adhesive remover is spaced inwardly from the ends of the applicator roller.

Example 18. The single facer system of any example herein, particularly any one of Examples 15-17, wherein the applicator roller comprises a groove defined in the surface of the applicator roller.

Example 19. The single facer system of any example herein, particularly any one of Examples 15-18, wherein the applicator roller is one of a plurality of applicator rollers, and the plurality of applicator rollers are spaced apart by gaps.

Example 20. The single facer system of any example herein, particularly any one of Examples 15-19, wherein: the adhesive applicator system further comprises an adhesive reservoir; and the adhesive reservoir comprises a plurality of adhesive baths spaced apart from each other along a length of the reservoir.

Example 21. A corrugator comprising the single facer system of any example herein, particularly any one of Examples 15-20.

Example 22. A single facer system, comprising: a pair of corrugating rollers positioned to receive medium from a roll of medium and form flutes in the medium to produce fluted medium; an applicator roller positioned to apply adhesive to flute tips of the fluted medium; and an adhesive remover positionable to remove adhesive from a selected portion of the applicator roller as the applicator roller rotates.

Example 23. A method, comprising: in a single facer system, drawing medium from a medium roll into a pair of corrugating rollers; with the corrugating rollers, forming flutes in the medium to produce fluted medium; with an applicator roller, applying adhesive to flute tips of the fluted medium; with an adhesive remover, removing adhesive from a selected portion of the applicator roller as the applicator roller rotates; and applying liner from a liner roll to the fluted medium to produce single face web.

Example 24. A single face web, comprising: a liner layer; and a fluted medium layer comprising a plurality of flutes extending across the fluted medium layer, the liner layer being adhered to the fluted medium layer; wherein the fluted medium layer comprises one or a plurality of zones extending perpendicular to a direction of the flutes that are free of adhesive.

Example 25. A shipping mailer, comprising: a first wall and a second wall that at least partially define an interior of the shipping mailer, the shipping mailer comprising a closed first end portion and a second end portion, the second end portion comprising an opening scalable by a closure; and a perforated tear-off strip formed along one side of the shipping mailer and extending in a direction from the closed first end portion toward the second end portion.

Example 26. The shipping mailer of any example herein, particularly Example 25, wherein the perforated tear-off strip comprises a first plurality of perforations formed in the first wall and a second plurality of perforations formed in the second wall.

Example 27. The shipping mailer of any example herein, particularly Example 26, wherein at least a portion of the perforations of the first plurality of perforations are aligned with perforations of the second plurality of perforations.

Example 28. The shipping mailer of any example herein, particularly Examples 26 or 27, wherein at least a portion of the perforations of the first plurality of perforations are offset from perforations of the second plurality of perforations.

Example 29. The shipping mailer of any example herein, especially any one of Examples 25-28, wherein the perforated tear-off strip is plastic-free.

Example 30. The shipping mailer of any example herein, particularly any one of Examples 25-29, wherein the shipping mailer comprises a single-face material or containerboard.

Example 31. A shipping mailer, comprising: a first wall and a second wall that at least partially define an interior of the shipping mailer, the shipping mailer comprising a closed first end portion and a second end portion, the second end portion comprising an opening scalable by a closure; the first wall and the second wall being formed by an edged single-face material comprising a fluted medium layer coupled to a liner layer, flutes of the fluted medium layer being disposed in the interior of the shipping mailer; the edged single-face material comprising finned edge portions in which the liner layer extends beyond the flutes of the fluted medium layer; wherein a finned edge portion of the first wall is overlaid and adhered to a finned edge portion of the second wall to form a sealed side edge of the shipping mailer; and wherein the finned edge portion of the first wall and the finned edge portion of the second wall each comprise a plurality of perforations that together define a tear-off strip that can be torn from the sealed side edge along the perforations to open the shipping mailer.

Example 32. The shipping mailer of any example herein, particularly Example 31, wherein at least a portion of the perforations of the first wall are aligned with perforations of the second wall.

Example 33. The shipping mailer of any example herein, particularly Examples 31 or 32, wherein at least a portion of the perforations of the first wall are offset from perforations of the second wall.

Example 34. The shipping mailer of any example herein, particularly one of Examples 31-33, wherein the perforated tear-off strip is plastic-free.

In view of the many possible embodiments to which the principles of the disclosed technology may be applied, it should be recognized that the illustrated embodiments are only examples and should not be taken as limiting the scope of the disclosure. Rather, the scope of the disclosure is at least as broad as the following claims and equivalents of the recited features. We therefore claim all that comes within the scope and spirit of these claims.

1. A shipping mailer, comprising:
a one-piece body comprising a first wall and a second wall that are folded together and sealed along sealed side edge portions of the one-piece body, the first and second walls at least partially defining an interior of the shipping mailer, the shipping mailer comprising a closed first end portion and a second end portion comprising an opening sealable by a closure;
the one-piece body comprising a single face corrugated material comprising a liner layer and a fluted medium layer;
the one-piece body comprising a center fold line at the closed first end portion from which the first and second walls extend;
the fluted medium layer comprising a plurality of flutes extending parallel or substantially parallel to the center fold line, wherein flutes of the first wall nest with flutes of the second wall; and
wherein the flutes are crushed in the sealed side edge portions such that the crushed flutes interlock in the sealed side edge portions, and the first and second walls fold along inner boundaries of the sealed side edge portions.

2. The shipping mailer of claim 1, wherein the inner boundaries of the sealed side edge portions form longitudinal fold lines between the crushed flutes of the sealed side edge portions and intact flutes of the interior of the shipping mailer.

3. The shipping mailer of claim 2, wherein the shipping mailer comprises a plurality of longitudinal fold lines formed in the flutes of the fluted medium layer and offset inwardly from the sealed side edge portions.

4. The shipping mailer of claim 1, wherein the fluted medium layer comprises a plurality of curved fold lines extending from the closed first end portion toward the opening of the second end portion, and the plurality of curved fold lines have respective concavities oriented toward sealed side edge portions of the shipping mailer.

5. The shipping mailer of claim 1, wherein the fluted medium layer comprises a plurality of first zones extending along the first wall and the second wall, the plurality of first zones comprising adhesive such that the liner layer and the fluted medium layer are adhered to each other in the plurality of first zones; and
wherein the fluted medium layer further comprises a second zone that is adhesive-free such that the liner layer and the fluted medium layer can move relative to each other in the adhesive-free second zone, the adhesive-free second zone being offset inwardly from the side edge portions of the one-piece body.

6. The shipping mailer of claim 5, wherein the adhesive-free second zone of the fluted medium layer is bounded on both sides by a first zone comprising adhesive.

7. The shipping mailer of claim 5, wherein the adhesive-free second zone is one of a plurality of adhesive-free second zones of the fluted medium layer, and each adhesive-free second zone of the plurality of adhesive-free second zones is bordered on both sides by a first zone comprising adhesive.

8. The shipping mailer of claim 5, wherein the fluted medium layer comprises a plurality of longitudinal fold lines formed in the flutes of the fluted medium layer, and the longitudinal fold lines are positioned in first zones of the fluted medium layer comprising adhesive.

9. The shipping mailer of claim 1, further comprising a perforated tear-off strip formed along one side of the shipping mailer and extending in a direction from the closed first end portion toward the second end portion.

10. The shipping mailer of claim 9, wherein the perforated tear-off strip comprises a first plurality of perforations formed in the first wall and a second plurality of perforations formed in the second wall.

11. The shipping mailer of claim 10, wherein at least a portion of the perforations of the first plurality of perforations are aligned with perforations of the second plurality of perforations, and at least a portion of the perforations of the first plurality of perforations are offset from perforations of the second plurality of perforations.

12. The shipping mailer of claim 9, wherein:
the shipping mailer defines a longitudinal axis that is perpendicular or substantially perpendicular to flutes of the fluted medium layer; and
perforations of the perforated tear-off strip comprise first portions that are parallel or substantially parallel to the longitudinal axis and second portions that extend toward a nearest side edge of the one-piece body at an angle to the longitudinal axis.

13. The shipping mailer of claim 1, wherein the first and second walls each comprise a perforation, and the perforations are on opposite sides of the center fold line.

14. The shipping mailer of claim 1, further comprising a perforation that extends from the first wall across the center fold line to the second wall.

15. A blank for forming the shipping mailer of claim 1.

16. A shipping mailer, comprising:
a one-piece body comprising a first wall and a second wall that are folded together and sealed along sealed side edge portions of the one-piece body, the first and second walls at least partially defining an interior of the shipping mailer, the shipping mailer comprising a closed first end portion and a second end portion comprising an opening sealable by a closure;
wherein the one-piece body comprises a single face corrugated material comprising a liner layer and a fluted medium layer; and
wherein the fluted medium layer comprises a plurality of first zones extending along the first wall and the second wall, the plurality of first zones comprising adhesive such that the liner layer and the fluted medium layer are adhered to each other in the plurality of first zones; and
wherein the fluted medium layer further comprises a second zone that is adhesive-free such that the liner layer and the fluted medium layer can move relative to each other in the adhesive-free second zone, the adhesive-free second zone being offset inwardly from the side edge portions of the one-piece body.

17. The shipping mailer of claim 16, wherein the adhesive-free second zone of the fluted medium layer is bounded on both sides by a first zone comprising adhesive.

18. The shipping mailer of claim 16, wherein the adhesive-free second zone is one of a plurality of adhesive-free second zones of the fluted medium layer, and each adhesive-free second zone of the plurality of adhesive-free second zones is bordered on both sides by a first zone comprising adhesive.

19. The shipping mailer of claim 16, wherein:
the one-piece body comprises a center fold line at the closed first end portion from which the first and second walls extend;
the fluted medium layer comprises a plurality of flutes extending parallel or substantially parallel to the center fold line; and
the fluted medium layer comprises a plurality of longitudinal fold lines formed in flutes of the fluted medium layer, and the longitudinal fold lines are positioned in first zones of the fluted medium layer comprising adhesive.

20. The shipping mailer of claim 19, wherein the longitudinal fold lines extend along inner edges of the sealed side edge portions of the shipping mailer.

21. The shipping mailer of claim 19, wherein:
a width of the fluted medium layer is equal to a width of the liner layer such that the flutes of the fluted medium layer extend from one side edge of the one-piece body to the other side edge of the one-piece body; and
flutes of the first wall nest with flutes of the second wall, and the flutes are crushed and interlock in the sealed side edge portions of the one-piece body.

22. The shipping mailer of claim 16, wherein the single face corrugated material is edged single face corrugated material and the liner layer extends beyond side edges of the fluted medium layer.

23. The shipping mailer of claim 19, wherein the fluted medium layer comprises a plurality of curved fold lines extending from the closed first end portion toward the opening of the second end portion, and the plurality of curved fold lines have respective concavities oriented toward sealed side edge portions of the shipping mailer.

24. The shipping mailer of claim 16, further comprising a perforated tear-off strip formed along one side of the shipping mailer and extending in a direction from the closed first end portion toward the second end portion.

25. A shipping mailer, comprising:
a one-piece body comprising a first wall and a second wall that are folded together and sealed along side edge portions of the one-piece body, the first and second walls at least partially defining an interior of the shipping mailer, the shipping mailer comprising a closed first end portion and a second end portion, the second end portion comprising an opening sealable by a closure; and
a perforated tear-off strip formed along one side of the shipping mailer and extending in a direction from the closed first end portion toward the second end portion, the perforated tear-off strip comprising a first plurality of perforations formed in the first wall and a second plurality of perforations formed in the second wall.
